(19) United States
(12) Patent Application Publication
(10) Pub. No.: US 2009/0235521 A1
(43) Pub. Date: Sep. 24, 2009

(54) Shield harness manufacturing method

(75) Inventors: Yoshiaki Suzuki, Makinohara (JP); Yoshinobu Akiha, Susono (JP); Nobuhiro Kakuhari, Makinohara (JP)

Correspondence Address: EDWARDS ANGELL PALMER & DODGE LLP, P.O. BOX 55874, BOSTON, MA, 02205, US

(73) Assignee: Yazaki Corporation, Tokyo (JP)

(21) Appl. No.: 12/382,433

(22) Filed: Mar. 17, 2009

(30) Foreign Application Priority Data
Mar. 18, 2008 (JP) 2008-069695
Feb. 9, 2009 (JP) 2009-026998

(51) Int. Cl. H01R 43/00

(52) U.S. Cl. 29/825

(57) ABSTRACT

A shield harness manufacturing device includes a sheet feeder, a conductor-winding mold, an insulator-winding mold, and a control unit. The conductor-winding mold winds an ALS sheet as an electrically conductive sheet around a wire bundle including at least one covered wire and at least one drain wire. The insulator-winding mold folds a PET sheet as an electrically insulating sheet into two halves and then wraps the ALS-wound wire bundle in the PET sheet over the entire length of the wire bundle. The sheet feeder feeds the ALS sheet into the conductor-winding mold through which the covered wire and the drain wire are passed. The ALS sheet is wound around the covered wire and the drain wire over the entire length of the wires. Thereafter, the ALS-wound wire bundle is inserted into the insulator-winding mold and the sheet feeder feeds the PET sheet into the insulator-winding mold.

### CROSS REFERENCE TO RELATED APPLICATION

The priority application Japan Patent Application No. 2008-069695 upon which this patent application is based is hereby incorporated by reference.

### BACKGROUND OF THE INVENTION

1. Field of the Invention

The present invention relates to a method for manufacturing a shield harness made by winding a conductive sheet around a periphery of a covered wire and a drain wire.

2. Description of the Related Art

An automobile as a movable body incorporates various electronic devices and wiring harnesses that supply power from a power source and/or transmitting and receiving control signals sent by microcontrollers and microprocessors to the electronic devices. The wiring harnesses of this kind is for example a shield harness that includes a plurality of covered wires that are bound together, a drain wire, and a shielding layer such as a braid covering the electrical wires and the drain wire, and a coating layer that covers the shielding layer.

The covered wire includes an electrically conductive core wire and a cover portion made of insulating synthetic resin that covers the core wire. The drain wire is only constituted by an electrically conductive core wire. The shielding layer such as the braid is formed by braiding electrically conductive strands. The covering layer is made of insulating synthetic resin.

As the wiring harness, a shield harness is used that is formed by winding an insulating tape around the periphery of the covered wire, the drain wire, and the shielding layer.

The shielding harness is electrically connected to a ground circuit via the drain wire and the shielding layer so that electrical noise that gets into the core wire of the electrical wire from without is reduced or electrical noise inherent in the core wire of the electrical wire is prevented from leaking to an outside.

### SUMMARY OF THE INVENTION

In the shielding harness that has a cover portion that covers the shielding layer, a weight of the cover portion is large, causing a weight of the shield harness as such to increase. In the shield harness that is formed by winding a tape around the periphery of the shielding layer, the shielding layer is easily exposed to an outside, undermining the shielding performance of the shield harness when the tape wound around the periphery of the shielding layer comes off.

In view of the above-identified problem, an object of the present invention is to provide a shield harness manufacturing method and device capable of providing a lightweight shield harness having improved shielding performance, the shield harness including an electrical wire, a conductive sheet wound around the electrical wire, and an insulating sheet wound around the conductive sheet that have been wound around the electrical wire.

In order to attain the objective, a method for manufacturing a shield harness according to one embodiment of the present invention includes an electrical wire, a conductive sheet covering the covered wire, and an insulating sheet covering the conductive wire, the method including (a) winding the conductive sheet around the electrical wire over a length of the electrical wire with one end of the electrical wire being secured, (b) folding the insulating sheet lengthwise such that the electrical wire and the conductive sheet wound around the electrical wire is placed between two halves of the insulating sheet, (c) winding the folded insulating sheet around the conductive sheet wound around the electrical wire; and (d) welding together one edge of the insulating sheet and the other edge of the insulating sheet over a length of the insulating sheet, with the one edge of the insulating sheet overlapped with the other edge of the insulating sheet over the length of the insulating sheet.

In one embodiment of the present invention, the shield harness manufacturing method includes wrapping the bundle of the electrical wires in the conductive sheet using the conductor-winding mold, and then the conductive sheet around the wires are further wrapped in the insulating sheet with the insulator shield folded into substantially two halves using the insulator-winding mold. Accordingly, the shield harness can be manufactured by wrapping the bundle of the electrical wires first in the conductive sheet and then in the insulating sheet.

The present invention is capable of manufacturing the shield harness by wounding first the conductive sheet around the periphery of the electrical wire and then winding the insulating sheet around the conductive sheet, eliminating the need of covering the external surface of the conductive sheet by the insulating synthetic resin, shield harness can be made more light-weight, so that the conductive sheet is not exposed to an outside, shielding performance can be improved.

Also, the conductor-winding mold wraps the bundle of the electrical wires in the conductive sheet. This means that the readily-plastically-deformed conductive sheet that has been rolled is wound around the periphery of the electrical wires, and accordingly the conductive sheet can be wound more adhesively and in stable contact with the electrical wire. Accordingly, the conductive sheet can be wound around the electrical wire more effectively and securely.

Further, the insulating sheet is collapsed by the insulator-winding mold and then wound around the conductive sheet. This means that not-readily-plastically-deformed insulating sheet is collapsed and wound around the periphery of the electrical wire without damage to insulating sheet. Accordingly, the insulating sheet can be wound around the electrical wire and the conductive sheet more effectively and securely.

In another embodiment, the present invention provides a method for manufacturing a shield harness including an electrical wire, a conductive sheet covering the covered wire, and first and second insulating sheets covering the conductive wire, the method including (a) winding the conductive sheet around the electrical wire over a length of the electrical wire with one end of the electrical wire being secured, (b) feeding the first insulating sheet and the second insulating sheet such that the electrical wire and the conductive wire wound around the electrical wire are positioned between the first insulating sheet and the second insulating sheet over the length of the electrical wire, (c) wrapping the electrical wire and the conductive sheet wound around the electrical wire in the first and second insulating sheets, and (d) welding together one edge of the first insulating sheet and one edge of the second insulating sheet over a length of the insulating sheets, and welding together the other edge of the first insulating sheet and the other edge of the second insulating sheet over the length of the insulating sheets, with the one edge of the first insulating sheet overlapped with the one edge of the second insulating sheet over the length of the insulating sheets, and with the other edge of the first insulating sheet overlapped with the other edge of the second insulating sheet over the length of the insulating sheets.

According to the shield harness manufacturing method with the construction and arrangement described above, the bundle of the electrical wires are wrapped in the conductive sheet using the conductor-winding mold, and then the conductive sheet is wrapped by the insulating sheet sandwiched by the insulator-winding mold. Thus, the shield harness can be manufactured by wrapping the bundle of the electrical wires first in the conductive sheet and then in the insulating sheet.

The present invention is capable of manufacturing the shield harness by wounding first the conductive sheet around the periphery of the electrical wire and then winding the insulating sheet around the conductive sheet conductive sheet, which eliminates the need of covering the external surface of the conductive sheet by the insulating synthetic resin, shield harness can be made more light-weight, so that the conductive sheet is not exposed to an outside, shielding performance can be improved.

Also, conductive sheet is rolled by the conductor-winding mold and then wound around the electrical wire. This means that readily-plastically-deformed the conductive sheet that has been rolled is wound around the periphery of the electrical wire, more adhesively and in stable contact with the electrical wire. Accordingly, the conductive sheet can be wound around the electrical wire more effectively and securely.

Further, the insulator-winding mold sandwiches the conductive sheet and wraps the conductive sheet in the conductive sheet. This means that the electrical wires are wrapped in the not-readily-plastically-deformed insulating sheet, thus the insulating sheet can be wound without causing damage to it. Accordingly, the insulating sheet can be wound around the electrical wire and the conductive sheet more effectively and securely. Further, the both ends in the width direction are welded together over the entire length of the two insulating sheet. Accordingly, the adjustment can be readily achieved by shifting the two welded portion in the width direction of the insulating sheet in response to variation in the number and the diameter of the electrical wires wrapped in the insulating sheet.

To address the aforementioned problem, the present invention is also directed to the shield harness manufacturing device according to one embodiment of the present invention includes (a) a conductor-winding mold that winds the electrically conductive sheet around the electrical wire over an entire length thereof, (b) an insulator-winding mold that folds the electrically insulating sheet passed therethrough such that the electrical wire and the conductive sheet wound around the electrical wire is placed lengthwise between two halves of the folded insulating sheet, winds the insulating sheet around the conductive sheet over a length of the conductive sheet, and joins by welding one edge and the other edge of the insulating sheet with the one edge being overlapped with the other edge over a length of the insulating sheet, (c) a sheet feeder that feeds the conductive sheet into the conductor-winding mold so that the conductive sheet is wound around the electrical wire over a length of the electrical wire, and feeds the insulating sheet into the insulator-winding mold so such that the insulator sheet is wound around the conductive sheet over a length of the conductive sheet, (d) an electrical-wire-holding unit that holds one end of an electrical wire that is passed through the conductor-winding mold and the insulator-winding mold, and (e) a control unit that controls manufacturing operation of the shield harness.

As it can be understood by the foregoing description, the manufacturing device according to one embodiment of the present invention is capable of manufacturing the shield harness by winding first the conductive sheet around the periphery of the electrical wire and then winding the insulating sheet around the conductive sheet, eliminating the need of covering the external surface of the conductive sheet by insulating synthetic resin and thus making the shield harness more light-weight. The insulating sheet is wound around the external surface of the conductive sheet so that the external surface is not exposed to an outside. In this manner, the shielding performance can be improved.

Also, since the conductive sheet that is readily plastically deformed is wound around the periphery of the electrical wire, the conductive sheet can be wound around the electrical wire more adherently and in stable contact with the electrical wire. Accordingly, the conductive sheet can be wound around the electrical wire more effectively.

Further, the insulating sheet is folded by the insulator-winding mold and then wound around the conductive sheet by the insulator-winding mold. This means that the insulating sheet that is not readily plastically deformed that has been collapsed is wound around the periphery of the electrical wire and, accordingly, the insulating sheet can be wound without damage around the electrical wire. Accordingly, the insulating sheet can be wound around the periphery of the electrical wire and the conductive sheet more effectively and securely.

In another preferred embodiment, the shield harness manufacturing device of the present invention includes the conductor-winding mold that winds the electrically conductive sheet around the electrical wire over a length of the electrical wire, and the insulator-winding mold that places the electrical wire and the conductive sheet wound around the electrical wire lengthwise between a first insulating sheet and a second insulating sheet, wraps the electrical wire and the conductive sheet wound around the electrical wire in the first and second insulating sheets, and welding together one edge of the first insulating sheet and one edge of the second insulating sheet over a length of the insulating sheets, and joins by welding one edge of the first insulating sheet and one edge of the second insulating sheet over the length of the insulating sheets, with the one edge of the first insulating sheet overlapped with the one edge of the second insulating sheet over the length of the insulating sheets, and joins by welding the other edge of the first insulating sheet and the other edge of the second insulating sheet, with the other edge of the first insulating sheet overlapped with the other edge of the second insulating sheet over the length of the insulating sheets.

With the construction and arrangement described above, the insulator-winding mold winds the insulating sheet around the conductive sheet that is sandwiched in between. This means that the not-readily-plastically-deformed insulating sheet is wound around the sandwiched electrical wire, and accordingly the insulating sheet can be wound without causing damage to the insulating sheet. Accordingly, the insulating sheet can be wound around the electrical wire and the conductive sheet more effectively and securely. Further, the one edge and the other edge of the insulating sheet is welded together over the entire length of the two insulating sheets. Accordingly, adjustment can be readily achieved by shifting the welded portions in the width direction of the insulating sheet in response to changes in the type and diameter of the electrical wire that are covered by the conductive and insulating sheets.

Preferably, the conductor-winding mold includes a main mold and a fastening mold, the main mold has a through-hole through which the electrical wire and the conductive sheet are passed, a diameter of the through-hole gradually decreasing toward downstreamwise in a feeding direction of the conductive and insulating sheets by the sheet feeder, the fastening mold is provided at a downstream edge of the main mold in the feeding direction and is configured to press the electrical wire and the conductive sheet against the main mold.

According to the shield harness manufacturing device with the construction and arrangement described above, the electrical wire and the conductive sheet are passed through the through-hole of the main mold of the conductor-winding mold, the diameter of the through-hole gradually decreasing. Accordingly, the conductive sheet can be effectively wound around the electrical wire.

Also, the fastening mold sandwiches the electrical wire and the conductive sheet between the fastening mold and the main mold. Accordingly, the shape of the conductive sheet sandwiched between these molds can be adapted to the shape of the electrical wire and facilitating winding of the conductive sheet around the electrical wire.

Preferably, the insulator-winding mold includes a main mold and a pair of clamping molds, the main mold receives therein the electrical wire and the conductive sheet, makes the insulating sheet take an U-shaped cross-section, and places the insulating sheet with the U-shaped cross-section at a periphery of the electrical wire and the conductive sheet, and the pair of clamping molds are configured to be moved close to and away from each other such that when the clamping molds are moved close to each other, the one edge and the other edge in the width direction of the insulating sheet are sandwiched by the clamping molds.

With the construction and arrangement described above, the main mold of the insulator-winding mold holds therein the insulating sheet such that the U-shaped cross-section is imparted to the insulating sheet, and the one edge and the other edge of the insulating sheet are sandwiched between the pair of clamping mold. Thus, winding of the insulating sheet around the electrical sire and the conductive sheet is facilitated.

Preferably, the shield harness manufacturing device of the present invention further includes a fixed unit that holds and joins one edge and the other edge in a width direction of the insulating sheet that is sandwiched between the pair of clamping molds.

With the construction and arrangement described above, the fixed unit binds the one edge and the other edge of the insulating sheet, and accordingly the insulating sheet is retained in a state where the insulating sheet is wound around the electrical wire and the conductive sheet. Thus, the insulating sheet can be held in a state where the electrical wires and the conductive sheet are wrapped in the insulating sheet.

Preferably, the shield harness manufacturing device of the present invention further includes a movable unit that moves the electrical wire, the conductive sheet, and the insulating sheet in a feeding direction of the conductive and insulating sheets by the sheet feeder.

With the construction and arrangement described above, the movable moves the electrical wire, the conductive sheet, and the insulating sheet, which allows the electrical wire, the conductive sheet, and the insulating sheet to be moved with the one edge and the other edge of the insulating sheet bound together by the fixed unit, and accordingly the one edge and the other edge of the insulating sheet can be firmly held over the entire length of the insulating sheet.

Conveniently, in the shield harness manufacturing device of the present invention, the electrical wire includes a covered wire that includes a core wire and a cover portion covering the core wire and a drain wire that only includes a core wire, and the electrical-wire-holding unit includes a rotatable holding unit that is rotatable and is configured to hold at its center the covered wire and hold at its peripheral region the drain wire, and the rotatable control unit turns at least one round of rotation in accordance with an instruction by the control unit.

The shield harness manufacturing device with the construction and arrangement described above has the rotatable holding unit that is rotated for at least one round of rotation, with the covered wire held at the central region and with the drain wire held at a peripheral region of the rotatable holding unit, thus ensuring that the drain wire is firmly in contact with the conductive sheet, so that the electrical noise can be effectively led via the drain wire to the ground circuit.

### BRIEF DESCRIPTION OF THE DRAWINGS

Other features, objects and advantages will become more apparent upon reading of the following detailed description in conjunction with the accompanying drawings in which:

FIG. 1 is a side elevation showing the configuration of the shield harness manufacturing device according to the first embodiment of the present invention.

FIG. 2A illustrates an end surface of the ALS guide of the fixed guide of the guide unit of the device shown in FIG. 1.

FIG. 2B illustrates an end surface of the ALS guide of the movable holding unit of the fixed guide of the guide unit of the device shown in FIG. 1.

FIG. 3 illustrates an end surface of the first PET guide of the guide unit of the device shown in FIG. 1.

FIG. 4 illustrates an end surface of the second PET guide of the guide unit of the manufacturing device shown in FIG. 1.

FIG. 5A illustrates an end surface of the sheet feeder of the guide unit of the device shown in FIG. 1.

FIG. 5B illustrates the ALS sheet that is sandwiched between the fixed pulley and the movable pulley above the sheet feeder shown in FIG. 5A.

FIG. 6A illustrates an end surface of the multiple-component-type guide of the guide unit of the device shown in FIG. 1.

FIG. 6B is a side elevation of the multiple-component-type guide shown in FIG. 6A.

FIG. 6C is a side elevation of the sliding blade that is superposed upon the multiple-component-type guide shown in FIG. 6B that is slid.

FIG. 7A illustrates an end surface of the conductor-winding mold of the conductor-winding unit of the manufacturing device shown in FIG. 1.

FIG. 7B is a plan view of the upper mold of the main mold of the conductor-winding mold viewed from the direction VIIb in FIG. 7A.

FIG. 7C illustrates an end surface of the conductor-winding mold shown in FIG. 7A.

FIG. 8A illustrates the upper mold and the lower mold of the main mold of the conductor-winding mold shown in FIG. 7C that are in close contact with each other.

FIG. 8B is a cross-sectional view showing the covered wires, the drain wire, and the ALS sheet that are sandwiched between the upper mold and the lower mold shown in FIG. 8A.

FIG. 8C is a side elevation of the conductor-winding mold and the movable holding unit shown in FIG. 8A.

FIG. 9A illustrates the covered wires, the drain wire, and the ALS sheet that are sandwiched between the lower mold and the fastening mold of the main mold of the conductor-winding mold shown in FIG. 8A.

FIG. 9B is a cross-sectional view showing the covered wires, the drain wire, and the ALS sheet that are sandwiched between the lower mold and the fastening mold shown in FIG. 9A.

FIG. 9C is a side elevation of the conductor-winding mold and the movable holding unit shown in FIG. 9A.

FIG. 10A illustrates end surface of the insulator-winding mold of the insulator-winding unit of the manufacturing device shown in FIG. 1.

FIG. 10B illustrates the PET sheet held by the main mold of the insulator-winding mold shown in FIG. 10A.

FIG. 10C is a cross-sectional view of the PET sheet held by the main mold shown in FIG. 10B.

FIG. 11A illustrates the pair of clamping molds of the insulator-winding mold shown in FIG. 10B that are moved close to each other.

FIG. 11B is a cross-sectional view showing the PET sheet whose ends in its width direction is sandwiched between the pair of clamping mold shown in FIG. 11A.

FIG. 12A illustrates the bottom mold of the main mold of the insulator-winding mold shown in FIG. 11A that is elevated.

FIG. 12B shows a cross-sectional view of the PET sheet shown in FIG. 12A.

FIG. 13A illustrates an end surface of the sheet chuck of the movable holding unit of the electrical-wire-holding unit of the manufacturing device shown in FIG. 1.

FIG. 13B illustrates the ALS sheet wound around the covered wire and the drain wire that is placed between the pair of chuck member of the sheet chuck shown in FIG. 13A.

FIG. 13C illustrates the ALS sheet wound around the covered wires and the drain wire that is sandwiched between the pair of chuck member shown in FIG. 13B.

FIG. 13D illustrates a pair of chuck member shown in FIG. 13C that are spaced from each other.

FIG. 13E illustrates the PET sheet is placed between the pair of chuck members of the sheet chuck shown in FIG. 13D.

FIG. 13F illustrates the PET sheet sandwiched between the pair of chuck members shown in FIG. 13E.

FIG. 14 illustrates end surface of the fixed unit of the manufacturing device shown in FIG. 1.

FIG. 15A illustrates an end surface of the electrical wire chuck of the movable holding unit of the electrical-wire-holding unit of the manufacturing device shown in FIG. 1.

FIG. 15B is a cross-sectional view of the movable holding unit of the electrical-wire-holding unit of the manufacturing device shown in FIG. 1.

FIG. 16 is a side elevation of the movable holding unit of the manufacturing device shown in FIG. 1 that is close to the conductor-winding mold.

FIG. 17 is a side elevation showing the of the insulator-winding mold placed between the movable holding unit and the conductor-winding mold of the insulator-winding mold manufacturing device shown in FIG. 16.

FIG. 18 is a side elevation showing the movable holding unit of the manufacturing device shown in FIG. 17 placed in a position close to the movable unit and away from the feeder.

FIG. 19 is a plan view of the rotatable holding unit of the electrical-wire-holding unit of the manufacturing device shown in FIG. 1.

FIG. 20 is a perspective view of an end of the shield harness that is manufactured by the manufacturing device shown in FIG. 1.

FIG. 21 is a cross-sectional view taken along the line XXI-XXI in FIG. 20.

FIG. 22 is a side elevation showing the configuration of the shield harness manufacturing device according to the second embodiment of the present invention.

FIG. 23A illustrates an end surface of the ALS guide of the fixed guide of the guide unit of the manufacturing device shown in FIG. 22.

FIG. 23B illustrates an end surface of the ALS guide of the fixed guide of the guide unit of the manufacturing device shown in FIG. 22.

FIG. 24 illustrates an end surface of the first PET guide of the guide unit of the manufacturing device shown in FIG. 22.

FIG. 25 illustrates an end surface of the second PET guide of the guide unit of the manufacturing device shown in FIG. 22.

FIG. 26 illustrates an end surface of the sheet feeder of the guide unit of the manufacturing device shown in FIG. 22.

FIG. 27A illustrates an end surface of the multiple-component-type guide of the guide unit of the manufacturing device shown in FIG. 22.

FIG. 27B is a side elevation of the multiple-component-type guide shown in FIG. 27A.

FIG. 27C is a side elevation showing the sliding blade superposed upon the multiple-component-type guide shown in FIG. 27B is slid.

FIG. 28A illustrates an end of the conductor-winding mold of the conductor-winding unit of the manufacturing device shown in FIG. 22.

FIG. 28B is a plan view of the upper mold of the main mold of the conductor-winding mold viewed from the direction VIIIb in FIG. 28A.

FIG. 28C illustrates an end of the conductor-winding mold shown in FIG. 28A.

FIG. 29A illustrates the upper mold and the lower mold of the main mold of the conductor-winding mold shown in FIG. 28C in close contact with each other.

FIG. 29B is a cross-sectional view of the covered wire, the drain wire, and the ALS sheet that are sandwiched between the upper mold and the lower mold shown in FIG. 29A.

FIG. 29C is a side elevation showing the conductor-winding mold and the movable holding unit shown in FIG. 29A.

FIG. 30A illustrates the covered wires, the drain wire, and the ALS that are sandwiched between the lower mold and the fastening mold of the main mold of the conductor-winding mold shown in FIG. 29A.

FIG. 30B is a cross-sectional view showing a state of the covered wires, the drain wire, and the ALS sheet that are sandwiched between the lower mold and the fastening mold shown in FIG. 30A.

FIG. 30C is aide elevation showing the conductor-winding mold and the movable holding unit shown in FIG. 30A.

FIG. 31A illustrates an end surface of the insulator-winding mold of the insulator-winding unit of the manufacturing device shown in FIG. 22.

FIG. 31B is a plan view of the upper mold of the insulator-winding mold viewed from a direction indicated by Ib in FIG. 31A.

FIG. 31C illustrates an end surface of the insulator-winding mold shown in FIG. 31A.

FIG. 32A illustrates the pair of clamping molds of the insulator-winding mold shown in FIG. 31C that are moved close to each other.

FIG. 32B is a cross-sectional view of the covered wires, the drain wire, and the ALS sheet and the PET sheet that are sandwiched between the pair of clamping molds shown in FIG. 32A.

FIG. 32C is a side elevation showing the insulator-winding mold and the movable holding unit shown in FIG. 32A.

FIG. 33A illustrates the pair of clamping molds shown in FIG. 32A that are brought into contact with each other.

FIG. 33B is a cross-sectional view showing the PET sheet whose both in the width direction is sandwiched between the pair of coupling molds shown in FIG. 33A.

FIG. 33C is a side elevation of the insulator-winding mold and the movable holding unit shown in FIG. 33A.

FIG. 34 illustrates an end surface of the fixed unit of the manufacturing device shown in FIG. 22.

FIG. 35 is a perspective view of an end of the shield harness that is manufactured by the manufacturing device shown in FIG. 22.

FIG. 36 is a cross-sectional view taken along the line IV-IV in FIG. 35.

FIG. 37 illustrates a welded portion where the edges of the PET sheet of the shield harness shown in FIG. 35 are welded together.

FIG. 38 is a side elevation of the configuration of the shield harness manufacturing device according to the third embodiment of the present invention.

FIG. 39A illustrates an end surface of the feeder of the multiple-component-type guide of the guide unit of the manufacturing device shown in FIG. 38.

FIG. 39B is a side elevation of the multiple-component-type guide shown in FIG. 39A.

FIG. 39C is a side elevation showing a state where the sliding blade superposed upon the multiple-component-type guide shown in FIG. 39B is slid.

FIG. 40 is a cross-sectional view of the shield harness that is manufactured by the manufacturing device shown in FIG. 38.

FIG. 41 illustrates a welded portion of the PET sheet of the shield harness shown in FIG. 38.

### DESCRIPTION OF THE PREFERRED EMBODIMENTS

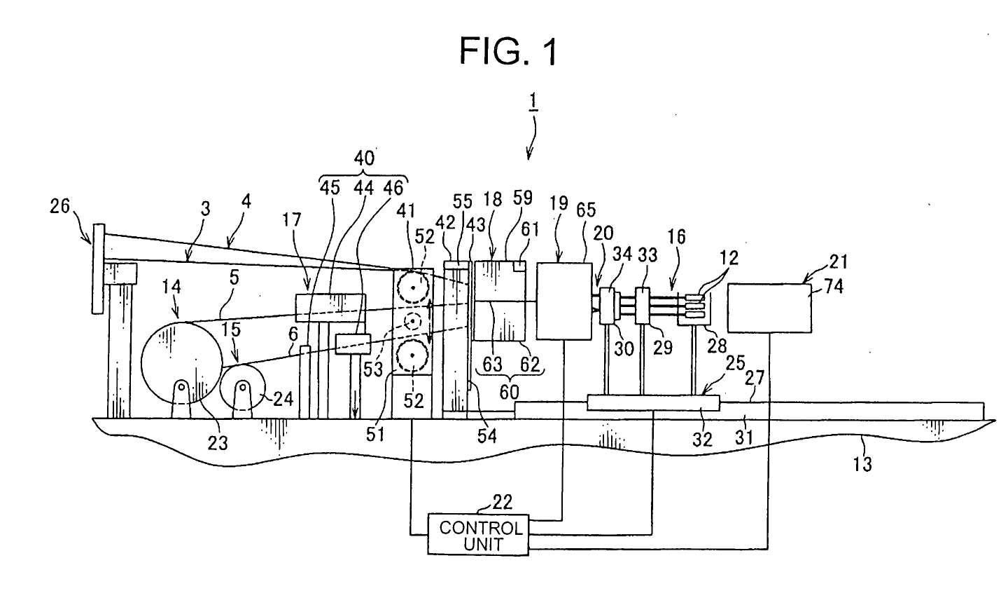

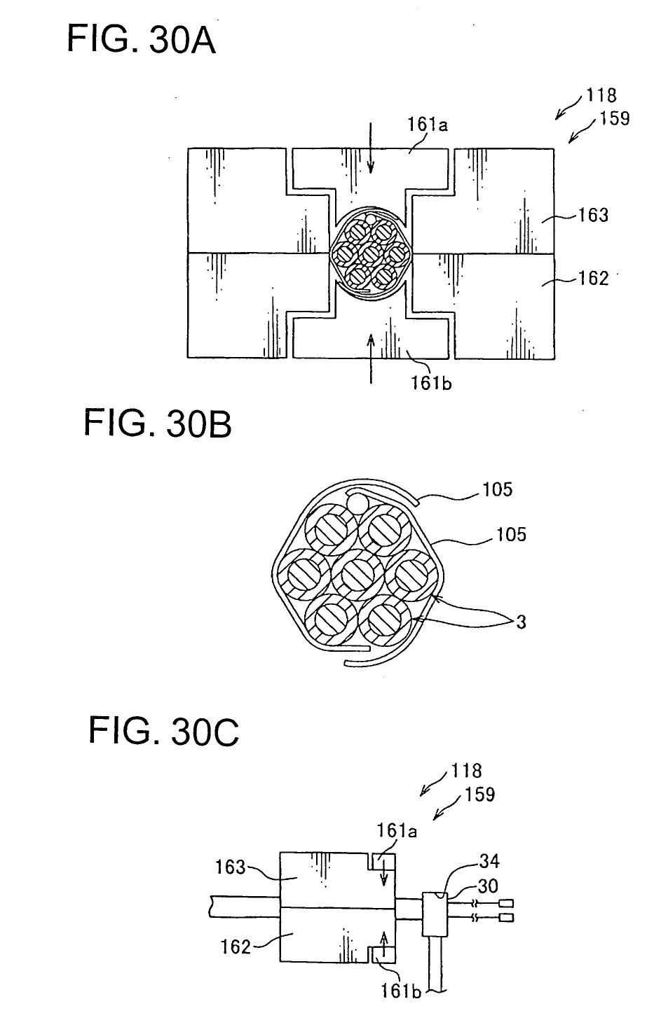

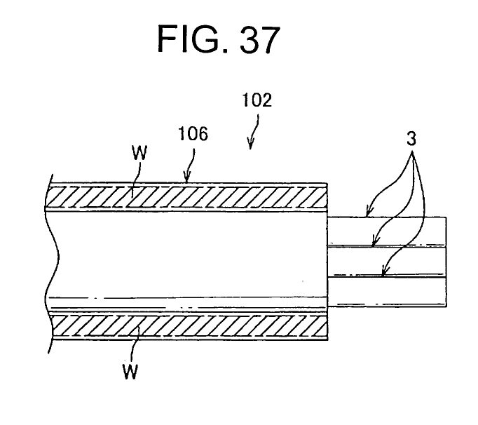

The following embodiments are described in order to provide a more precise understanding of a shield harness manufacturing device (hereafter simply called a manufacturing device) of the present invention with reference to FIGS. 1 to 41.

### First Embodiment

The manufacturing device according to the first embodiment of the present invention is described below with reference to FIGS. 1 to 21.

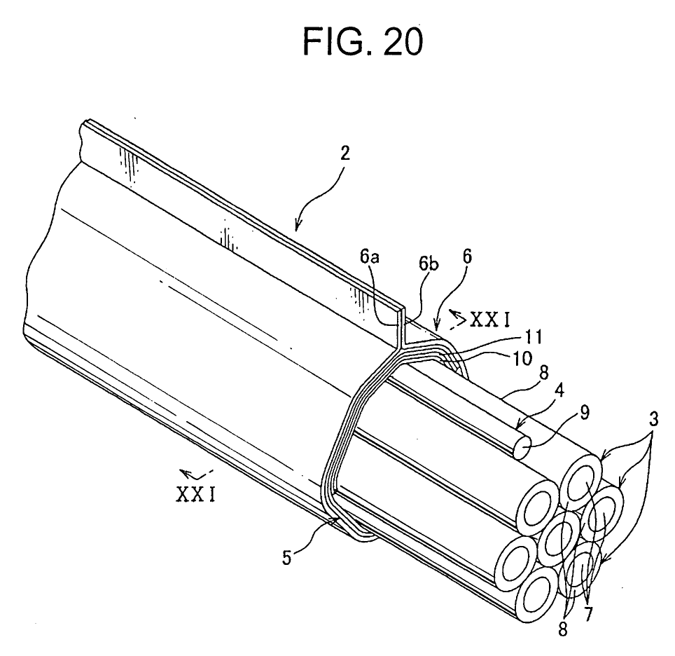

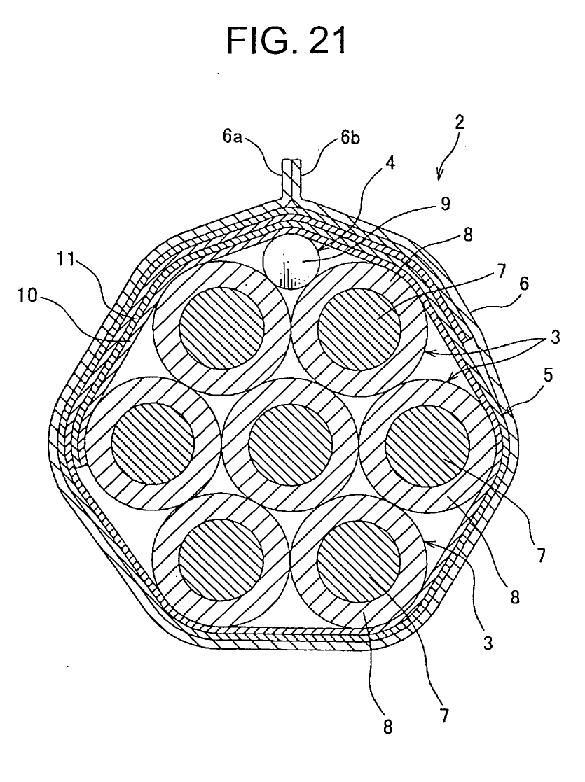

Referring to FIG. 1, the manufacturing device 1 is an apparatus that manufactures a shield harness 2 shown in FIGS. 20 and 21. The shield harness 2 includes two types of electrical wires, i.e., (a) at least one covered wire 3 (a plurality of covered wires 3 in the embodiments), and (b) a drain wire 4, (c) an aluminum-laminated sheet 5 (hereafter called an ALS sheet) as a conductive sheet, and (d) a polyethylene terephthalate sheet 6 (hereafter called a PET sheet) as an insulating sheet.

The covered wires 3 parallel to each other are bundled together. The covered wire 3 includes a core wire 7 and a cover portion (or sheath) covering the core wire 7. The core wire 7 may be one single wire or made of conductor strands that are twisted together. The core wire 7 has a circular cross-section. The conductor strands of the core wire 7 are made of electrically conductive metal. The core wire 7 is flexible and the cover portion 8 covering the core wire 7 is made of electrically insulating synthetic resin and also flexible.

The drain wire 4 is only constituted by a core wire 9 made of electrically conductive metal. The core wire 9, in a similar manner as in the core wire 7 of the covered wire 3, may be one single wire or made of wire strands that are twisted together.

As shown in FIG. 21, the core wire 9 has a circular cross-section. The drain wire 4 as viewed in cross-section is not surrounded by the plurality of covered wires 3: The drain wire 4 is disposed between the two covered wires 3 and the ALS sheet 5 at a peripheral region, i.e., a region radially outward of the central region of the shield harness 2. The significance of this arrangement of the drain wire 4 will be explained later.

The ALS sheet 5 is a thin sheet or strip that includes a thin conductive layer 10 and a thin insulating layer 11 laminated upon the conductive layer 10. The conductive layer 10 is made of electrically conductive metal having flexibility. The conductive layer 10 includes at least aluminum or aluminum alloy. The insulating layer 11 is made of electrically insulating synthetic resin having flexibility.

The ALS sheet 5 is wound around a wire bundle, i.e., the covered wires 3 and the drain wire 4 that are bundled in the above-described manner (without use of a tape that is wound around a portion of the wires). As shown in FIG. 21, the ALS sheet 5 is wound with the conductive layer 10 inside, i.e., always facing the center of the shield harness 2, and with the conductive layer outside, or more specifically, such that the conductive layer 11 that is being wound always comes into contact with the insulating layer 11 that has already been wound, so that winding of the ALS sheet is finished with the insulating layer 11 constituting an outer surface of the ALS-wound wire bundle. In addition, as shown in FIG. 21, the conductive layer 10 of the ALS sheet 5 is in contact with an outer surface of the drain wire 4 at the peripheral region of the shield harness 2.

The PET sheet 6 is a thin sheet (or a strip) made of electrically insulating synthetic resin having flexibility such as polyethylene terephthalate.

The shield harness 2 is manufactured by (a) bundling together the covered wires 3 and the drain wire 4 into the wire bundle such that the drain wire 4 is not surrounded by the covered wires 3 but placed outermost of the bundled wires, (b) winding the ALS sheet 5 around the wire bundle with the conductive layer 10 coming inside, and then (c) wrapping the ALS-wound wire bundle in the PET sheet 6. The ALS sheet and the PET sheet 6 are in parallel with the covered wires 3 and the drain wire 4 lengthwise of the shield harness 2. The ALS sheet is wound around the bundle of the covered wires 3 and the drain wire 4, and the ALS-wound wire bundle is wrapped in the PET sheet 6, with the one edge 6a and the other edge 6b lengthwise of the PET sheet 6 are brought into contact with each other over the entire length of the PET sheet 6, and the two edges 6a and 6b are joined together by welding to form a joint over the entire length of the PET sheet 6. This is a brief overview of how the shield harness 2 according to the first embodiment of the present invention is manufactured.

Further, a terminal fitting 12 (partially illustrated in FIG. 15B) and a connector housing (not shown) are attached to one end and the other end of the covered wires 3 and the drain wire 4 of the shield harness and then the terminal fittings 12 is received in a connecter housing in a known manner, attached, inserted, or connected into a connector housing (not shown). Further, the connector housing connected to the shield harness 2 is connected to an automotive electronic device to transmit and receive signals to and from the device and/or supply power to the devices.

Further, the conductive layer 10 of the ALS sheet of the shield harness 2 is connected via the drain wire 4 to a ground circuit so that external electrical noise entering the core wire 7 of the covered wire 3 and electrical noise going out of the core wire 7 of the covered wire 3 are led via the conductive layer 8 of the ALS sheet 5 and the drain wire 4 to the ground circuit.

The manufacturing device 1 is an apparatus that winds the ALS sheet around the bundle of the covered wires 3 and the drain wire 4 that have been cut in a predetermined length and with terminal fittings 12 attached to the one end and the other end thereof, and then wrap the ALS-wound wire bundle in the PET sheet 6 so that the ALS sheet 5 is covered by the PET sheet 6.

Referring to FIG. 1, the manufacturing device 1 has a body 13 of the manufacturing device 1, an ALS feeder 14, a PET feeder 15, an electrical-wire-holding unit 16, a guide unit 17, a conductor-winding unit 18, an insulator-winding unit 19, a fixed unit 20, a movable unit 21, and a control unit 22.

The body 13 of the manufacturing device 1 is for example installed on a floor of a factory of an automobile manufacturer. The body 13 has rectangular shape with a flat upper surface.

The ALS feeder 14 and the PET feeder 15 are disposed upon the upper surface of the body 13 of the manufacturing device 1. The feeders 14 and 15 have reels 23 and 24, respectively. The reels 23 and 24 are rotatably supported by the body 13. The ALS sheet 5 and the PET sheet 6 in a shape of an elongated strip are wound around the reels 23 and 24, respectively.

The electrical-wire-holding unit 16 has a movable holding unit 25 and a rotatable holding unit 26. The movable holding unit 25, when viewed from the rotatable holding unit 26, is provided at the other end of the body 13. The movable holding unit 25 has a linear guide 27, a carrier cylinder (not shown), a terminal holder 28, an electrical-wire-chuck portion 29, and a sheet-chuck portion 30.

The linear guide 27 has a slider 32 and a rail 31 extending straight and mounted on the body 13. The rail 31 extends parallel to the length of the body 13. The slider 32 is mounted on the rail 31 and carried by the carrier cylinder (not shown) so as to be slidable lengthwise of the rail 31.

The terminal holder 28, the electrical-wire-chuck portion 29, and the sheet-chuck portion 30 are mounted (aligned from right to left as shown in FIG. 1) on the slider 32. The terminal holder 28 is mounted at a rightmost region (as viewed in FIG. 1) of the slider 32. Referring to FIG. 15B, the terminal holder 28 is configured to hold the terminal fitting 12 so as to hold one end of the wire bundle (i.e., the covered wires 3 and the drain wire 4) by for example hooking the terminal fitting 12 of the wire bundle. Note that, for simplicity, only one covered wire 3 is illustrated in FIG. 15B with other wires omitted.

The electrical-wire-chuck portion 29 is provided at the centre of the slider 32 and next to the terminal holder 28. As shown in FIG. 15A, the electrical-wire-chuck portion 29 has a pair of chuck members 33 that can be moved close to and away from each other such that one end of the wire bundle to which the terminal fitting 12 is attached is sandwiched betwixt the chuck members 33.

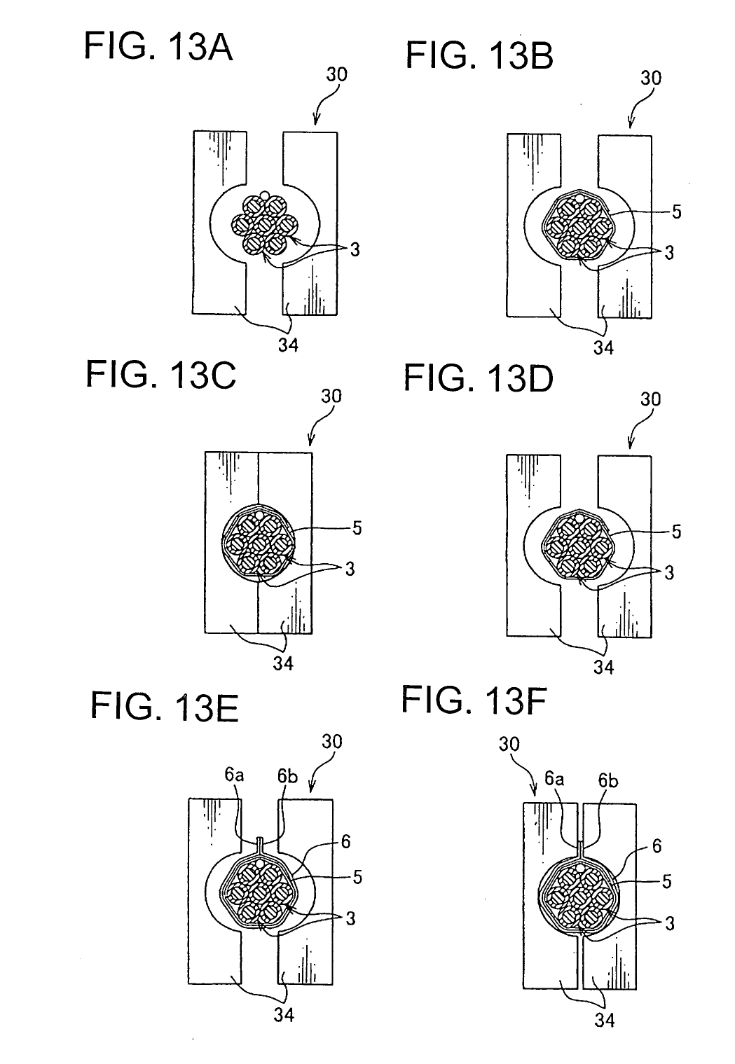

The sheet-chuck portion 30 is provided at a leftmost region of the slider 32 and next to electrical-wire-chuck portion 29. As shown in FIGS. 13A to 13F, the sheet-chuck portion 30 has a pair of chuck members 34 that can be moved close to and away from each other such that one end of the ALS sheet 5 and the PET sheet 6 wound around the wire bundle to the terminal fitting 12 is attached is sandwiched between the pair of chuck members 34.

The movable holding unit 25 holds one end of these covered wires 3 and the drain wire 4 by the terminal holder 28 holding the terminal fitting 12, the electrical-wire-chuck portion 29 chucking and holding the covered wire 3, and the sheet-chuck portion 30 chucking and holding the ALS sheet and the PET sheet 6.

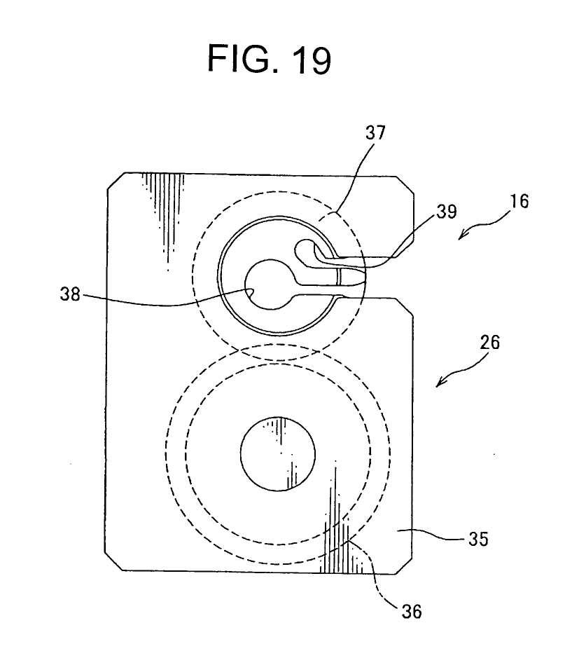

The rotatable holding unit 26 is disposed on one end of the body 13 of the manufacturing device 1. As shown in FIG. 19, the rotatable holding unit 26 has a pair of base plates 35 secured to the body 13, a driving gear 36, and a driven gear 37. The base plates 35 are arranged spaced from and in parallel with each other.

The driving gear 36 and the driven gear 37 are each formed in a shape of a thick disk and provided between the pair of base plates 35 so as to be rotatable about an axis. The driving gear 36 is driven by a motor (not shown) as a driving source to be rotatable about its axis. The driven gear 37 is engaged with the driving gear 36 and driven by the above motor so as to be rotatable about its axis.

The driven gear 37 has the electrical-wire-holding slit 38 that holds the other end of the covered wire 3 at the central region of the driven gear 37 by hooking the other end of the covered wire 3, and a drain wire holding slit 39 that holds the other end of the drain wire 4 by hooking the other end of the drain wire 4 provided at its periphery.

The electrical-wire-holding slit 38 is configured to hold the other end of the covered wire 3, and the drain wire holding slit 39 is configured to hold the other end of the drain wire 4, so that the other edges of the covered wire 3 and the drain wire 4 are held.

Referring again to FIG. 1, the guide unit 17 has a fixed guide 40, a sheet feeder 41, a multiple-component-type guide 42, and a sliding blade 43. The guide unit 17 is provided near the feeders 14 and 15 and between the feeders 14, 15 and the movable holding unit 25. The fixed guide 40 is provided near the feeders 14 and 15 and has an ALS-guide 44, a first PET-guide 45, and a second PET-guide 46.

The ALS-guide 44, the first PET-guide 45, and the second PET-guide 46 are secured to the body 13 of the manufacturing device 1. The ALS-guide 44 is formed in a shape of a rectangular body lengthwise parallel to the length of the body 13.

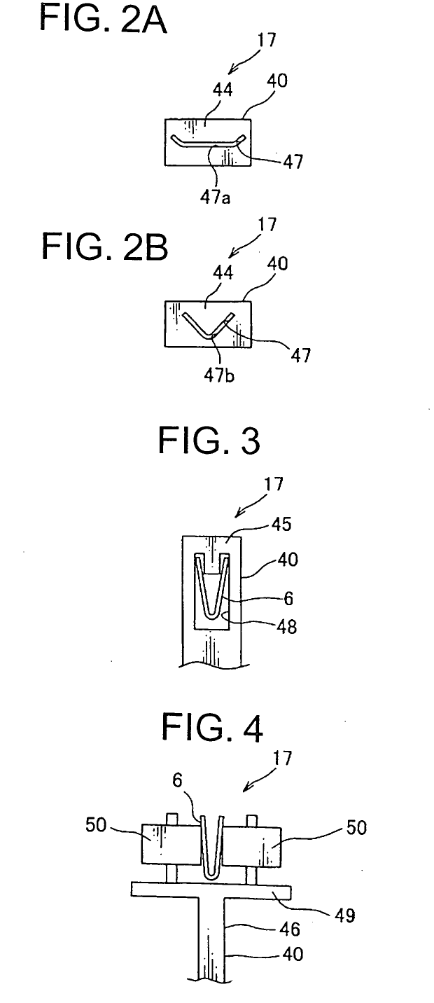

Referring to FIGS. 2A and 2B, the ALS-guide 44 has a guide hole 47 that extends lengthwise through the ALS-guide 44 so that the ALS sheet 5 can be passed through the guide hole 47. The guide hole 47 has a V-shaped cross-section that becomes more acute gradually from the side of feeders 14, 15 toward the side of the movable holding unit 25. This means that the opening 47b (see FIG. 2B) facing the movable holding unit 25 is more acute angled than the opening 47a (see FIG. 2A) facing the feeders 14 and 15.

Referring to FIG. 3, the first PET-guide 45 is formed in a shape of a bar. At an upper end of the first PET-guide 45, a guide hole 48 through which the PET sheet 6 20 is passed is formed. The guide hole 48 makes the PET sheet 6 inserted therein take a V-shaped cross-section.

As shown in FIG. 1, the second PET-guide 46 is provided near the first PET-guide 45 and closer to the movable holding unit 25 than the first PET-guide 45 is. Referring to FIG. 4, the second PET-guide 46 has a body 49 secured to the body 13 of the manufacturing device 1 and a pair of guide rollers 50. The body 49 has a flat upper surface. The pair of guide rollers 50 are provided such that their peripheral surfaces are spaced from each other. The guide rollers 50 are rotatably supported on the body 49. The second PET-guide 46 makes the PET sheet 6 between the guide rollers 50 take a V-shaped cross-section.

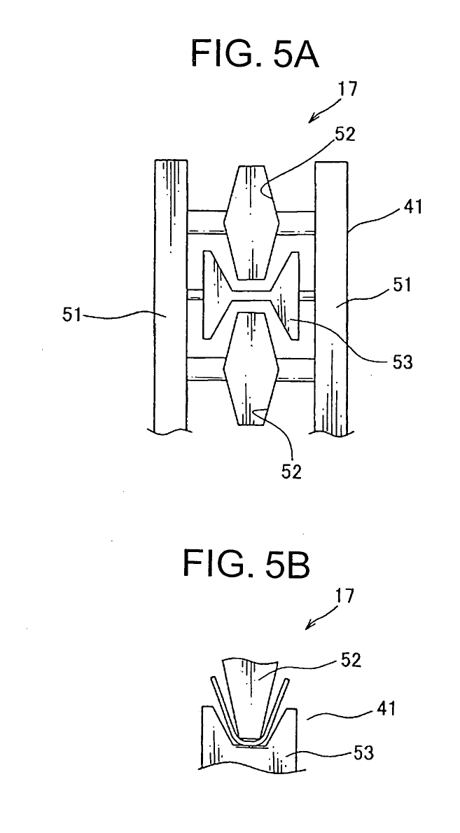

The sheet feeder 41 is provided near the guides 44, 45, and 46 and closer to the movable holding unit 25 than the guides 44, 45, and 46 are. As shown in FIG. 5A, the sheet feeder 41 has a pair of base plates 51, two fixed pulleys 52, and one movable pulley 53.

The pair of base plates 51 upstand from the body 13 of the manufacturing device 1 and arranged in parallel with and spaced from each other in a width direction of the body 13 of the manufacturing device 1. The two fixed pulleys 52 are provided between the pair of base plates 51 and spaced from each other in a vertical direction. The movable pulley 53 is provided between the pair of fixed pulleys 52 and secured rotatably to the pair of base plates 51. Also, the movable pulley 53 is movable between the fixed pulleys 52, i.e., can be moved close to and away from each of the fixed pulleys 52. The movable pulley 53 is driven by a motor (not shown).

The sheet feeder 41 feeds the ALS sheet 5 or the PET sheet 6 toward the movable holding unit 25 with the ALS sheet or the PET sheet 6 sandwiched the between the sheet feeder 41 and the one fixed pulley 52 and by being moved close to one of the a pair of fixed pulleys 52 and by being driven by the motor. Also, in the drawings, when the movable pulley 53 is moved close to the upper fixed pulley 52 of the pair of fixed pulleys 52, the ALS sheet 5 is fed. When the movable pulley 53 is moved close to the lower fixed pulley 52 of the pair of fixed pulleys 52, the PET sheet 6 is fed.

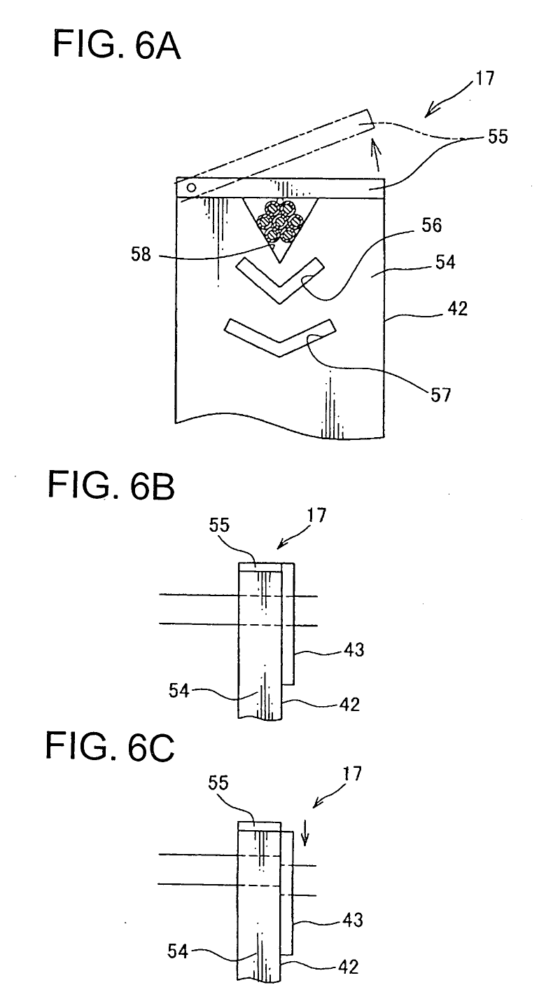

The multiple-component-type guide 42 is provided near the sheet feeder 41 and closer to the movable holding unit 25 than the sheet feeder 41 is. As shown in FIG. 6A, the multiple-component-type guide 42 has a columnar guide body 54 and a cover 55.

The guide body 54 is formed in a shape of a quadratic prism that upstands from the body 13 of the manufacturing device 1. An ALS-guide hole 56 and a PET-guide hole 57 extend through the guide body 54. The ALS-guide hole 56 is provided at the heightwise centre of the guide body 54, and extends over the length of the guide body 54 in the longitudinal direction of the body 13 of the manufacturing device 1. The ALS-guide hole 56 has a V-shaped cross-section. The ALS sheet 5 is passed through the ALS-guide hole 56. Note that the term “heightwise centre” does not refer to FIG. 1 but it is only specific to the illustration of FIG. 6.

The PET-guide hole 57 is provided lower than the heightwise centre of the guide body 54 and extends through the guide body 54 in the longitudinal direction of the body 13 of the manufacturing device 1. The PET-guide hole 57 has a V-shaped cross-section. The valley of the PET-guide hole 57 is less acute-angled than that of the ALS-guide hole 56. The PET sheet 6 is passed through the PET-guide hole 57.

Also, the guide body 54 has an electrical-wire-guiding groove 58. The electrical-wire-guiding groove 58 is formed concave on the upper surface of the guide body 54, and extends straight in the longitudinal direction of the body 13 of the manufacturing device 1. The electrical-wire-guiding groove 58 has a V-shaped cross-section. The valley of the electrical-wire-guiding groove 58 is more acute-angled than that of the ALS-guide hole 56 (and accordingly that of the PET-guide hole 57). The covered wires 3 and the drain wire 4 are passed through the electrical-wire-guiding groove 58.

The cover 55 is formed in a shape of a thick flat plate. The cover 55 is mounted on the upper end of the columnar guide body 54 to be pivotable about an axis between a closed position where the electrical-wire-guiding groove 58 is closed by the cover 55 and an open position where the top of the electrical-wire-guiding groove 58 is wide open.

The sliding blade 43 is formed in a shape of a strip. The sliding blade 43 is superposed on a lateral surface of the guide body 54 of the multiple-component-type guide 42, the lateral surface facing the movable holding unit 25, and configured to be slidable in a vertical direction. The sliding blade 43 has a guide hole that registers with the ALS-guide hole 56 and the PET g57 so that the ALS sheet 5 and PET sheet 6 are passed therethrough. The sliding blade 43 is slid relative to the guide body 54 in the vertical direction, so that the ALS sheet 5 and the PET sheet 6 are cut by the sliding blade 43 on the lateral surface of the guide body 54.

The conductor-winding unit 18 is provided near the multiple-component-type guide 42 and closer to the movable holding unit 25 than the multiple-component-type guide 42 is. As shown in FIG. 1, the conductor-winding unit 18 has a conductor-winding mold 59 and a cylinder unit (not shown).

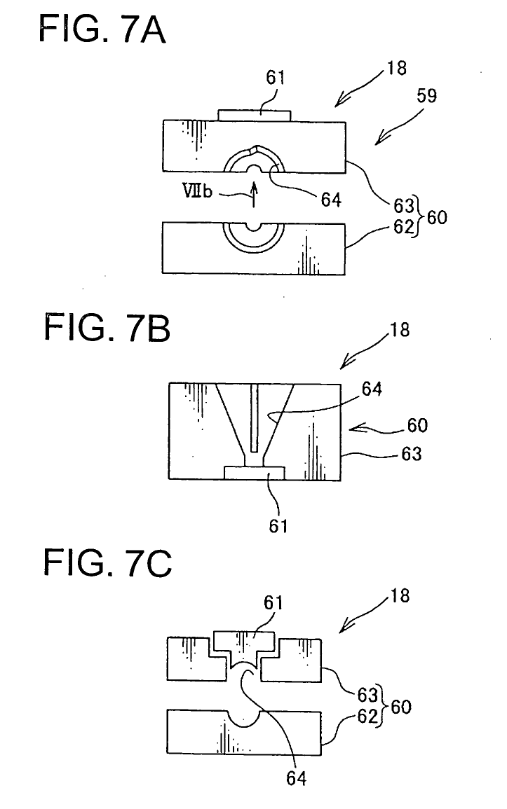

Referring to FIG. 7A, the conductor-winding mold 59 has a main mold 60 and a fastening mold 61. The main mold 60 has a lower mold 62 and an upper mold 63 on top of lower mold 62 in a vertical direction, both of which are formed in a shape of a thick flat plate. The lower mold 62 and the upper mold 63 can be moved, in the vertical direction, close to each other (until finally in contact with each other) and away from each other so as to be detached from each other.

The lower mold 62 and the upper mold 63 defines a through-hole 64 therebetween, through which the covered wires 3 and the ALS sheet 5 covering the covered wires 3 are passed. The through-hole 64 is constituted by two concave grooves facing each other, i.e., a concave groove formed on a surface of the lower mold 62 and a concave groove formed on a surface of the upper mold 63 that comes into contact with the surface of the lower mold 62. The through-hole 64 is a round hole whose diameter decreases gradually from the side of the multiple-component-type guide 42 toward the side of the movable holding unit 25 while the lower mold 62 and the upper mold 63 are in contact with each other. This means that the diameter of the through-hole 64 decreases gradually toward a downstream region in a feeding direction of the sheet feeder 41. The covered wires 3 and the ALS sheet 5 positioned around the covered wires 3 are passed through the through-hole 64 as the lower mold 62 and the upper mold 63 are moved close to each other, and thus the ALS sheet 5 is wound around the covered wires 3.

The fastening mold 61, as shown in FIG. 7B, is mounted on an end of the upper mold 63 of the main mold 60, the end being closer to the movable holding unit 25 (a rightmost end of the main mold 60 in the feeding direction of the ALS sheet 5 and PET sheet 6 by the sheet feeder 41). The fastening mold 61 is mounted on the upper mold 63 slidably in the vertical direction. When the fastening mold 61 is moved close to the lower mold 62, the covered wires 3, the drain wire 4, and the ALS sheet 5 wound around these wires are sandwiched between the fastening mold 61 and the lower mold 62.

The cylinder unit moves these molds 62, 63, and 64 in the vertical direction so that the molds 62, 63, and 64 are moved close to and away from each other.

The insulator-winding unit 19 is provided near the conductor-winding unit 18 and closer to the movable holding unit 25 than the conductor-winding unit 18 is. As shown in FIG. 1, the insulator-winding unit 19 has an insulator-winding mold 65 and a shifting unit (not shown).

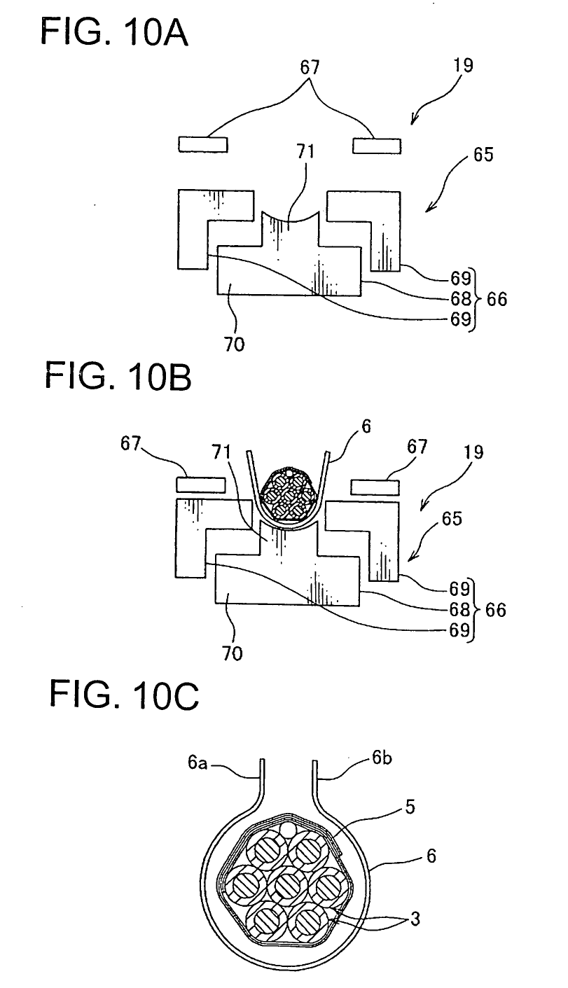

Referring to FIG. 10A, the insulator-winding mold 65 has a main mold 66 and a pair of clamping molds 67. As shown in FIG. 10A and also in FIG. 10B, the main mold 66 includes one bottom mold 68 and a pair of guide molds 69. The bottom mold 68 has a body 70 formed in a shape of a thick flat plate and a wire-rest portion 71 that protrudes from an upper surface of the body 70. The wire-rest portion 71 extends in a linear fashion lengthwise of the body 13 of the manufacturing device 1 and provided over the entire length of the body 70. The upper surface of the wire-rest portion 71 has a concave upper surface with an arc-shaped cross section. Also, the wire-rest portion 71 can be slid relative to the pair of guide molds 69 in the vertical direction.

The pair of guide molds 69 are spaced from each other in the width direction of the body 13 of the manufacturing device 1, and the wire-rest portion 71 of the bottom mold 68 is positioned between the guide molds 69 in the width direction. The surfaces of the guide molds 69 facing each other is formed flat in the vertical direction and in the longitudinal direction of the body 13 of the manufacturing device 1. With the guide mold 69 moved down, the surface of the guide mold 69 and the upper surface of the wire-rest portion 71 of the bottom mold 68 together takes a U-shaped cross-section.

The bottom mold 68 and the pair of guide molds 69 can be integrally raised and lowered. Also, the main mold 66, while in a state where the bottom mold 68 is lowered relative to the guide molds 69, places the PET sheet 6, which is positioned at a periphery of the ALS-wound wire bundle, on the upper surface of the wire-rest portion 71 of the bottom mold 68, and places the PET surface 6 between the surfaces of the pair of guide molds 69 opposed to each other. Thus, the body 70 makes the PET sheet 6 that is positioned at the periphery of the ALS-wound wire bundle take a U-shaped cross-section.

The pair of clamping molds 67 are each formed in a shape of a strip extending in a linear fashion lengthwise of the body 13 of the manufacturing device 1 and are spaced from each other in the width direction of the body 13 of the manufacturing device 1. Also, the pair of clamping molds 67 are provided above the main mold 66 and can be moved close to and away from (raised or lowered with respect to) the main mold 66. The pair of clamping molds 67 are together moved close to the main mold 66 and also close to each other so as to sandwich the one edge 6a and the other edge 6b of the PET sheet 6 provided on the main mold 66.

The shifting unit moves the main mold 66 and the pair of clamping molds 67 integrally in the width direction of the body 13 of the manufacturing device 1. The main mold 66 and the pair of clamping molds 67 can be moved in the longitudinal direction of the body 13 of the manufacturing device 1 from a position where they are closely aligned with the main mold 60 and fastening mold 61 of the conductor-winding unit 18 to a position where they are not closely aligned with these molds 60 and 61.

Also, the shifting unit raises and lowers the bottom mold 68 and the pair of guide mold 69 of the main mold 66 integrally, and raises and lowers the pair of clamping molds 67 integrally. Further, the shifting unit raises and lowers the bottom mold 68 relative to the guide mold 69 of the main mold 66, and makes the pair of guide molds 69 move close to and away from each other.

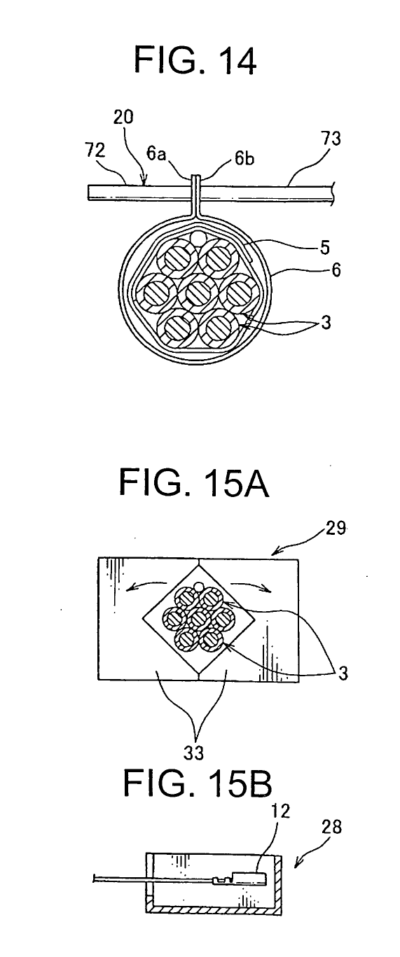

The fixed unit 20 is provided near the insulator-winding unit 19 and closer to the movable holding unit 25 than the insulator-winding unit 19 is. As shown in FIG. 14, the fixed unit 20 has a horn 72 and an anvil 73 that are moved close to and away from each other, a piezoelectric vibrator (not shown) that brings the horn 72 into ultrasonic vibration, and a cylinder unit (not shown) that makes the horn 72 and the anvil 73 move close to and away from each other.

The horn 72 and the anvil 73 are spaced from each other in the width direction of the body 13 of the manufacturing device 1. The horn 72 and the anvil 73 are each configured in a form of a strip lengthwise parallel to the width of the body 13 of the manufacturing device 1. The piezoelectric vibrator makes the horn 72 vibrate with small amplitude at a frequency of for example 20 KHz.

The cylinder of the fixed unit 20 moves the horn 72 and the anvil 73 close to each other, so that the one edge 6a and the other edge 6b widthwise of the PET sheet 6 is sandwiched between the horn 72 and the anvil 73. The piezoelectric vibrator causes ultrasonic vibration of the horn 72, and frictional heat occurs at the one edge 6a and the other edge 6b of the PET sheet 6, so that the one edge 6a and the other edge 6b are joined together by welding.

The movable unit 21 is provided at a region more distant from the feeders 14 and 15 than the fixed unit 20 is. The movable unit 21 has a pair of belt units 74 that are spaced from each other and moved close to and away from each other in the width direction of the body 13 of the manufacturing device 1 and a cylinder unit (not shown) that makes the belt units 74 move close to and away from each other. Each of the belt units 74 has a driving pulley that is driven by a motor, a rotatable driven pulley spaced from the driving pulley, and an endless belt provided around the pulleys. The belt unit 74, via the rotation of the driving pulley, runs the endless belt around the pulleys. The movable unit 21 moves the pair of belt units 74 close to each other and makes the belt units 74 sandwich the ALS-wound wire bundle and the PET sheet 6 covering the ALS-wound wire bundle, with the endless belt of the belt unit 74 running, the ALS-wound wire bundle and the PET sheet 6 covering the ALS-wound wire bundle are moved in the longitudinal direction. This means that the movable unit 21 moves the ALS-wound wire bundle and the PET sheet 6 covering the ALS-wound wire bundle in the feeding direction of the ALS and PET sheets 5, 6 by the sheet feeder 41.

The control unit 22 is a microcontroller (or microprocessor) incorporating a known read-only memory (ROM) unit, a random access memory (RAM) unit, and a central processing unit (CPU). The control unit 22, which controls the entire functionality and operation of the manufacturing device 1, is connected to and controls the electrical-wire-holding unit 16, the guide unit 17, the conductor-winding unit 18, the insulator-winding unit 19, the fixed unit 20, and the movable unit 21.

The control unit 22 stores information including an interval at which the ALS sheet 5 and the PET sheet 6 are cut. The control unit 22, on the basis of the stored information, controls the carrier cylinder and chuck portions 29 and 30 of the movable holding unit 25 of the electrical-wire-holding unit 16, the motor of the rotatable holding unit 26, the sheet feeder 41 of the guide unit 17, the cylinder unit of the conductor-winding unit 18, the movable unit of the insulator-winding unit 19, the piezoelectric vibrator and the cylinder unit of the fixed unit 20, and the motors of the belt units 74 of the movable unit 21, and winds the ALS sheet 5 around the covered wires 3 and the drain wire 4 that have been cut in a predetermined length with the terminal fitting 12 attached to both ends of the wires 3 and 4, and then wraps the ALS-wound wire bundle in the PET sheet 6, and joins by welding the one edge 6a and the other edge 6b of the PET sheet 6.

It should be noted that the each steps of the manufacturing method achieved by the manufacturing device 1 is controlled by the control unit 22. Accordingly, even when not explicitly recited in the following sections, each functional units of the manufacturing device dedicated to a specific action is controlled by the instruction of the control unit 22.

Having fully described the construction and arrangement of the manufacturing device 1 according to the first embodiment, the following describes how the shield harness 2 is manufactured by the manufacturing device 1 by applying first the ALS sheet 5 and then the PET sheet 6 around the covered wires 3 and the drain wire 4 that are cut in the predetermined length with the terminal fittings 12 attached to the both end thereof.

As preparatory operation, the terminal fitting 12 has to be attached to one end of the covered wires 3 and the drain wire 4. Then the covered wires 3 and the drain wire 4 are hooked onto the terminal holder 28 of the movable holding unit 25 of the electrical-wire-holding unit 16, and then the one end of the covered wires 3 and the drain wire 4 is held by the terminal holder 28. Meanwhile, the other end of the covered wire 3 is inserted into the electrical-wire-holding slit 38 of the driven gear 37 of the rotatable holding unit 26 such that the other end of the covered wires 3 are held. Likewise, the other end of the drain wire 4 is inserted into the drain-wire-holding slit 39 of the driven gear 37 of the rotatable holding unit 26 so that the other end is held. Further, the central portion of the covered wires 3 and the drain wire 4 is received in the electrical-wire-guiding groove 58 of the multiple-component-type guide 42 of the guide unit 17, and the opening of the electrical-wire-guiding groove 58 is closed by the cover 55.

Further, the tip of the ALS sheet 5 wound around the reel 23 of the ALS feeder 14 is passed through the guide hole 47 of the ALS-guide 44 of the fixed guide 40 of the guide unit 17 and then between the fixed pulley 52 provided at an upper portion of the sheet feeder 41 and the movable pulley 53 provided at a central portion of the sheet feeder 41, and further into the ALS-guide hole 56 formed on the columnar guide body 54 of the multiple-component-type guide 42 so as to be in contact with the sliding blade 43.

Also, the tip of the PET sheet 6 wound around the reel 24 of the PET feeder 15 is passed (in order of appearance below) through the guide hole 48 of the first PET-guide 45 of the fixed guide 40 of the guide unit 17, between the guide rollers 50 of the second PET-guide 46, and between the fixed pulley 52 provided at a lower portion of the sheet feeder 41 and the movable pulley 53 of the sheet feeder 41. The tip of the PET sheet 6 is inserted into the PET-guide hole 57 provided on the columnar guide body 54 of the multiple-component-type guide 42 so as to be in contact with the sliding blade 43.

Upon completion of the preparatory operation, the manufacturing device 1 is now ready to start manufacturing operation.

The movable pulley 53 at the upper portion of the sheet feeder 41 is moved close to the fixed pulley 52, and, as shown in FIG. 5B, the pulleys 52 and 53 sandwich the ALS sheet 5 between them. The sliding blade 43 is placed at a position where the guide hole of the sliding blade 43 registers with and communicates with the guide holes 56 and 57 of the multiple-component-type guide 42 (shown in FIG. 6A). As shown in FIGS. 7A and 7C, the lower mold 62 and the upper mold 63 of the conductor-winding unit 18 move away from each other, and the fastening mold 61 is moved away from the lower mold 62. The covered wires 3 and the drain wire 4 is placed between the upper mold 63 and the lower mold 62.

The main mold 66 and the pair of clamping molds 67 of the insulator-winding unit 19 are placed all together at a position where they are not closely aligned with the conductor-winding unit 18 in the longitudinal direction of the body 13 of the manufacturing device 1. As shown in FIG. 10A, the main mold 66 and the pair of clamping molds 67 of the insulator-winding unit 19 are moved away from each other, and the bottom mold 68 is lowered relative to the pair of guide molds 69. The pair of clamping molds 67 are spaced away from each other.

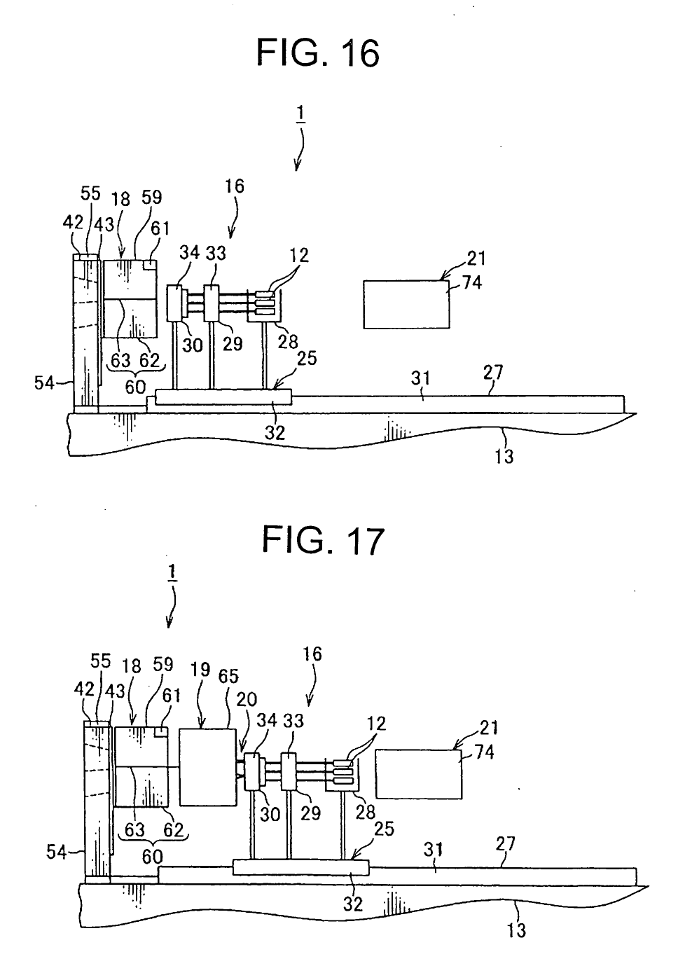

As shown in FIG. 16, the slider 32 of the movable holding unit 25 (and accordingly the terminal holder 28, the electrical-wire-chuck portion 29, and the sheet-chuck portion 30) are placed most proximate to the conductor-winding unit 18, and the pair of chuck members 33 of the electrical-wire-chuck portion 29 are moved close to each other, so that the covered wires 3 and the drain wire 4 are sandwiched between them. Further, as shown in FIG. 13A, the pair of chuck members 34 of the sheet-chuck portion 30 are spaced from each other. The pair of belt units 74 of the movable unit 21 are also spaced from each other, and the horn 72 and the anvil 73 of the fixed unit 20 are spaced from each other.

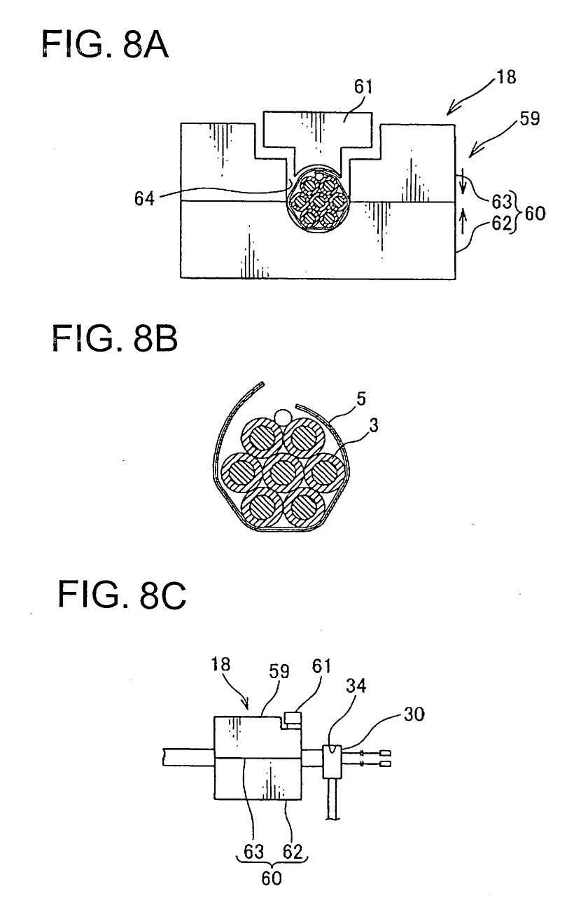

Next, as shown in FIGS. 8A and 8C, the upper mold 63 and the lower mold 62 of the conductor-winding unit 18 are placed in direct contact with each other, so that the covered wires 3 and the drain wire 4 are sandwiched between the molds 62 and 63. Thus, the covered wires 3 and the drain wire 4 are passed through the conductor-winding mold 59.

After that, the motor (not shown) drives and rotates the movable pulley 53 of the sheet feeder 41, so that the ALS sheet 5 is fed into the through-hole 64 of the main mold 60 of the conductor-winding mold 59 of the conductor-winding unit 18. Since the diameter of the through-hole 64 gradually decreases toward the side of movable holding unit 25, the ALS sheet 5 is guided by the inner surface of the through-hole 64 (see FIG. 8B), and gradually wound around the wire bundle (i.e., the covered wire 3 and the drain wire 4).

When the tip of the ALS sheet 5 is passed through the through-hole 64 and placed between the pair of chuck members 34 of the sheet-chuck portion 30 (see FIG. 13B), the movable pulley 53 of the sheet feeder 41 stops rotating and the pair of chuck members 34 of the sheet-chuck portion 30 move close to each other (see FIG. 13C), and thus the tip of the covered wires 3, the drain wire 4, and the ALS sheet 5 is sandwiched between the chuck members 34.

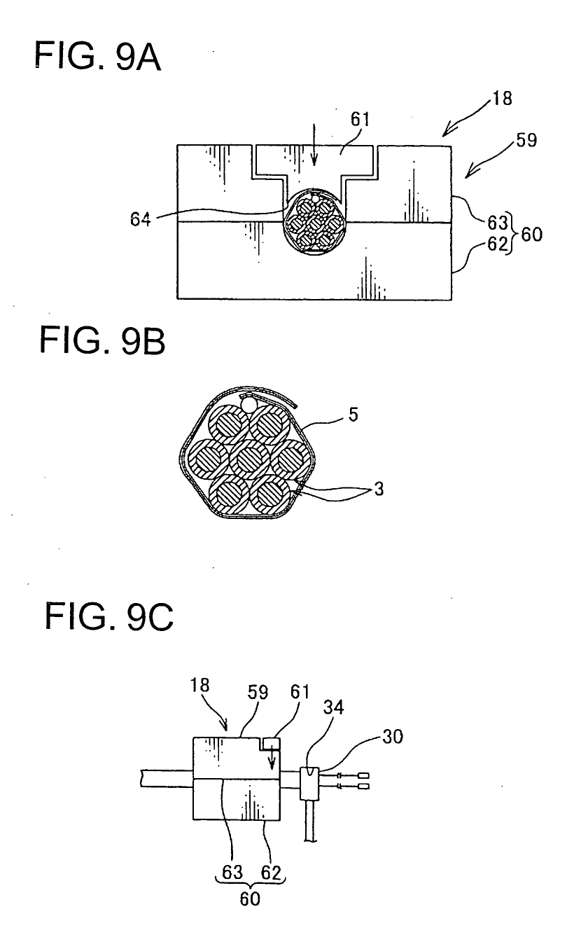

Following this, as shown in FIGS. 9A and 9C, the fastening mold 61 of the conductor-winding mold 59 is lowered and the tip of the covered wires 3, the drain wire, and the ALS sheet 5 is sandwiched between the fastening mold 61 and the lower mold 62. After that, as shown in FIG. 9B, the ALS sheet 5 is wound around the wire bundle so that the wire bundle and the ALS sheet 5 is in intimate contact with each other.

After that, the slider 32 of the movable holding unit 25 (and accordingly the terminal holder 28, the electrical-wire-chuck portion 29, and the sheet-chuck portion 30) is moved away from the conductor-winding unit 18. Further, the insulator-winding mold 65 is moved along with the movable unit 21 of the insulator-winding unit 19, so that the insulator-winding mold 65 is placed at a position where the insulator-winding mold 65 is closely aligned with the conductor-winding mold 59 of the conductor-winding unit 18 in the longitudinal direction of the body 13 of the manufacturing device 1. In this manner, as shown in FIG. 17, the insulator-winding unit 19 is placed between the conductor-winding unit 18 and the movable holding unit 25. Thereafter, as shown in FIG. 13D, the pair of chuck members 34 of the sheet-chuck portion 30 are moved away from each other and the movable pulley 53 provided at the lower portion of the sheet feeder 41 of the guide unit 17 is moved close to the fixed pulley 52, so that the PET sheet 6 is sandwiched between the pulleys 52 and 53.

Thereafter, the movable pulley 53 of the sheet feeder 41 is driven by the motor (not shown) and rotated, so that the PET sheet 6 is fed onto the upper surface of the wire-rest portion 71 of the bottom mold 68 of the main mold 66 of the insulator-winding mold 65 of the insulator-winding unit 19 shown in FIG. 10A. Since the U-shaped cross-section is defined by the upper surface of the wire-rest portion 71 of the bottom mold 68 and the surface of the two guide molds 69, the PET sheet 6 is guided by the upper surface of the wire-rest portion 71 and the surface of the pair of guide mold 69. As shown in FIGS. 10B and 10C, the PET sheet 6 is folded into substantially two halves and is disposed around the ALS-wound wire bundle.

Following this, the pair of clamping molds 67 are lowered, and, as shown in FIG. 10B, the pair of clamping molds 67 are placed very close to (but not in direct contact with) the pair of guide molds 69 of the main mold 66.

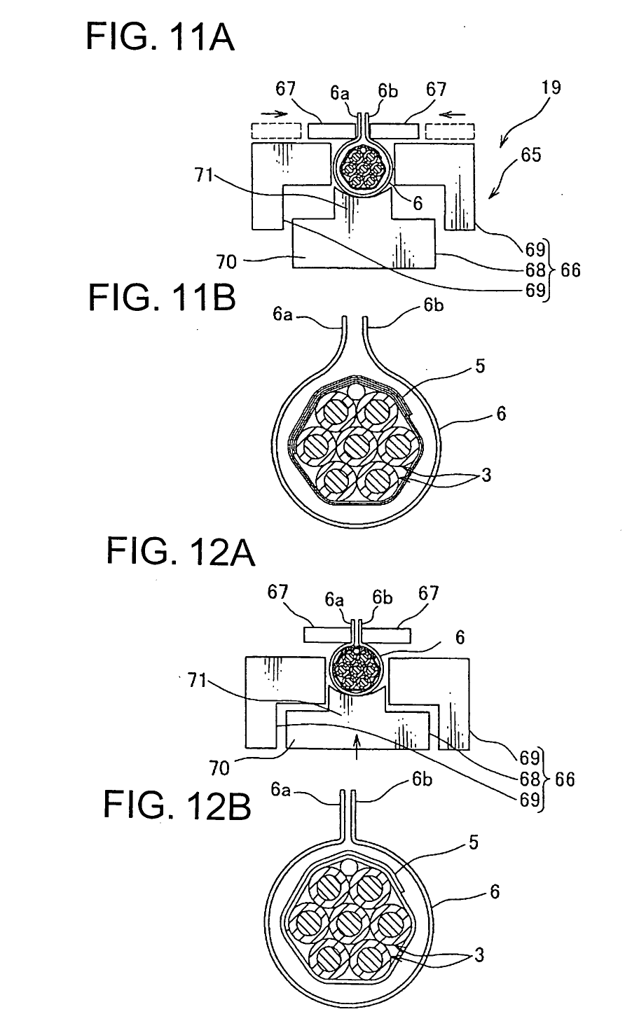

After that, when the tip of the PET sheet 6 rests upon the wire-rest portion 71 and is passed between the pair of guide molds 69, and, as shown in FIG. 13E, is placed between the pair of chuck members 34 of the sheet-chuck portion 30, then the movable pulley 53 of the sheet feeder 41 stops rotating and the pair of chuck members 34 of the sheet-chuck portion 30 are moved close to each other. Further, as shown in FIG. 13F, the tip of the covered wires 3, the drain wire 4, the ALS sheet 5, and the PET sheet 6 is sandwiched between the chuck members 34, and, as shown in FIG. 11A, the pair of clamping molds 67 of the insulator-winding unit 19 are moved close to each other so that the one edge 6a and the other edge 6b of the PET sheet 6 are sandwiched between the pair of clamping molds 67. Then, as shown in FIG. 11B, the PET sheet 6 is folded into substantially two halves and covers therein the bundle of the covered wires 3, the drain wire 4, and the ALS sheet 5, so that the one edge 6a and the other edge 6b of the PET sheet 6 comes in close contact with each other.

Thereafter, as shown in FIG. 12A, the bottom mold 68 of the insulator-winding unit 19 is raised and the tip of the covered wires 3, the drain wire 4, the ALS sheet 5, and the PET sheet 6 is sandwiched between the bottom mold 68 and the pair of clamping molds 67. After that, as shown in FIG. 12B, the PET sheet 6 is folded into substantially two halves, covering the ALS-wound wire bundle such that the ALS-wound wire bundle and the PET sheet 6 are in intimate contact with each other.

Following this, as shown in FIG. 14, the horn 72 and the anvil 73 of the fixed unit 20 are moved close to each other so that the one edge 6a and the other edge 6b of the PET sheet 6 is clamped between the horn 72 and the anvil 73 with the horn 72 under ultrasonic vibration by the ultrasonic oscillator. Then, frictional heat occurs at portions of the one edge 6a and the other edge 6b of the PET sheet 6 that are clamped between the horn 72 and the anvil 73 and, as a result, the two ends 6a and 6b of the PET sheet 6 are welded together. Thereafter, the slider 32 of the movable holding unit 25 (and accordingly the terminal holder 28, the electrical-wire-chuck portion 29, and the sheet-chuck portion 30) is moved away from the conductor-winding unit 18. As the movable holding unit 25 is moving, the covered wires 3, the drain wire 4, the ALS sheet 5, and the PET sheet 6 are moved away from the conductor-winding unit 18, and the portions of the one edge 6a and the other edge 6b of the PET sheet 6 that are clamped between the horn 72 and the anvil 73 are also moved, and as a result the one edge 6a and the other edge 6b of the PET sheet 6 are welded in the longitudinal direction in response to movement relative to the conductor-winding unit 18.

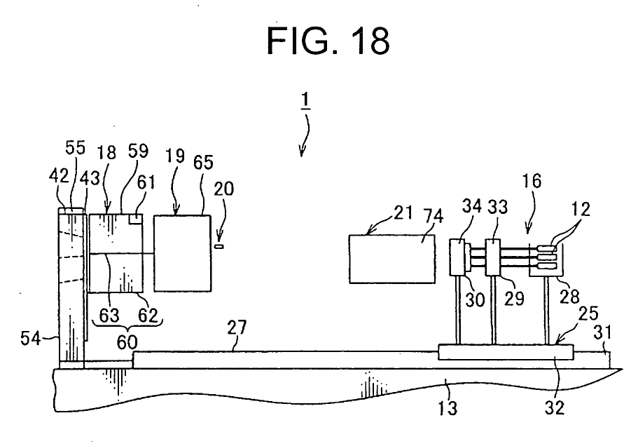

After that, when, as shown in FIG. 18, the slider 32 of the movable holding unit 25 (and accordingly the terminal holder 28, the electrical-wire-chuck portion 29, and the sheet-chuck portion 30) is placed at a position more distant from the rotatable holding unit 26 than the pair of belt units 74 of the movable unit 21 is, then the slider 32 stops moving. Thereafter, the pair of belt units 74 of the movable unit 21 are moved close to each other, so that the PET sheet 6 wound around the ALS-wound wire bundle is sandwiched between the belt units 74. Also, the pair of chuck member 33 of the electrical-wire-chuck portion 29 are moved away from each other, and the pair of chuck members 34 of the sheet-chuck portion 30 are moved away from each other, and the driving pulley of the belt unit 74 of the movable unit 21 is rotated. Further, the covered wires 3, the drain wire 4, and the ALS sheet 5, and the PET sheet 6 are moved all together away from the feeders 14 and 15.

Thereafter, when the ALS sheet 5 and the PET sheet 6 are moved for a predetermined distance, as shown in FIG. 6C, the sliding blade 43 slides relative to the guide body 54 of the multiple-component-type guide 42, and cuts the ALS sheet 5 and the PET sheet 6, and, immediately before sliding of the sliding blade 43 and accordingly immediately before cutting of the ALS sheet 5 and the PET sheet 6, the motor of the rotatable holding unit 26 is driven to cause only one round of rotation of the driven gear 37. After that, since the other end of the drain wire 4 is held at a periphery of the driven gear 37, the drain wire 4 is positioned at a peripheral region of the circular cross section of the wire bundle, and comes into direct contact with the conductive layer 10 of the ALS sheet 5. Thus, the rotatable holding unit 26 of the electrical-wire-holding unit 16 controlled by the control unit 22 causes at least one round of rotation of the driven gear 37.

Following this, the sliding blade 43 slides again, and places the sliding blade 43 at a position where the guide hole of the sliding blade 43 registers with the guide holes 56 and 57 of the multiple-component-type guide 42, and the endless belt of the belt unit 74 of the movable unit 21 runs so that the ALS-wound wire bundle including the covered wires 3 and the drain wire 4 and the PET sheet 6 covering the ALS-wound wire bundle are moved to a position more distant from the feeders 14 and 15 than the movable holding unit 25 is.

The manufacturing of the shield harness 2 is thus completed.

The shield harness manufacturing device and the shield harness manufacturing method according to the first embodiment of the present invention have the following advantages.

The conductor-winding mold 59 is provided to wind the ALS sheet 5 around the wire bundle constituted by the covered wires 3 and the drain wire 4, and the insulator-winding mold 65 is provided to wind the PET sheet 6 around the ALS sheet 5 that has been wound around the wire bundle. Thus, the shield harness 2 is manufactured by winding first the ALS sheet 5 and then the PET sheet 6 around the bundle of the covered wires 3 and the drain wire 4.

Accordingly, the shield harness 2 can be made more light-weight since the need of covering the external surface of the ALS sheet 5 by an insulating synthetic resin is eliminated. Also, since the PET sheet 6 covers the external surface of the ALS sheet 5, the ALS sheet 5 wound around the wire bundle can be protected against being exposed to an outside, and thus shielding performance of the shield harness 2 can be improved.

Also, since the ALS sheet 5 that is wound around the wire bundle by the conductor-winding mold 59 is readily plastically deformed the ALS sheet 5 can be wound more adhesively and in more stable contact with the covered wire 3 and the drain wire 4. Accordingly, the ALS sheet 5 can be wound around the wire bundle effectively.

Further, the insulator-winding mold 65 folds the PET sheet 6 into substantially two halves and wraps the ALS-wound wire bundle in the folded PET sheet 6. Since the PET sheet 6 that is not readily plastically deformed is folded into substantially two halves and wound around the ALS-wound wire bundle, the PET sheet 6 can be wound without causing damage to the PET sheet 6. Thus, the not-readily-plastically-deformed PET sheet 6 can be effectively wound around the ALS-wound wire bundle.

Since the covered wires 3, the drain wire 4, and the ALS sheet 5 are inserted into the through-hole 64 of the main mold 60 of the conductor-winding mold 59, the diameter of the through-hole 64 gradually decreasing, the ALS sheet 5 can be effectively wound around the wire bundle.

In addition, since the ALS sheet 5 is sandwiched between the fastening mold 61 and the main mold 60, the wound ALS sheet 5 is clamped between the two molds so that the ALS sheet 5 can be snugly wound around the wire bundle.

Since the main mold 66 of the insulator-winding mold 65 holds the PET sheet 6 in such a manner that the cross-section of the PET sheet 6 takes an U-shape and the one edge 6a and the other edge 6b of the PET sheet 6 are clamped between the pair of clamping molds 67, the PET sheet 6 can be wound around the ALS-wound wire bundle with the PET sheet 6 folded substantially into two halves.

Since the one edge 6a and the other edge 6b of the PET sheet 6 are joined with each other by the fixed unit 20, the two edges of the PET sheet 6 can be joined together with the PET sheet 6 wound around the covered wires 3, the drain wire 4, and the ALS sheet 5.

By virtue of the moving unit 21 that carries the covered wires 3, the drain wire 4, the ALS sheet 5, and the PET sheet 6, the ALS-wound wire bundle covered by the PET sheet 6 can be moved with the one edge 6a and the other edge 6b of the PET sheet 6 held by the fixed unit 20. Thus, the one edge 6a and the other edge 6b of the PET sheet 6 can be joined together over the entire length of the PET sheet.

Since the driven gear 37 holds the covered wire 3 at the center of the driven gear 37 and holds the drain wire 4 at the peripheral region of the driven gear 37 and the covered wires 3 are turned for at least one round of rotation, at least a portion of the drain wire 4 can be placed at a periphery relative to the cross section of the wire bundle so as to ensure that the drain wire 4 is brought into contact with the ALS sheet 5 wound around the wire bundle. Accordingly, the electrical noise can be effectively led via the drain wire 4 to the ground circuit.

Although, in the first embodiment, the shield harness 2 includes the plurality of covered wires 3 and only one drain wire 4, the shield harness 2 contemplated in the present invention can have only one covered wire 3 and one drain wire 4.

In addition, although the two edges of the PET sheet 6 are joined together by welding. Joining together of the two edges of the PET sheet 6 can be achieved by adhesive bonding using a suitable adhesive.

### Second Embodiment

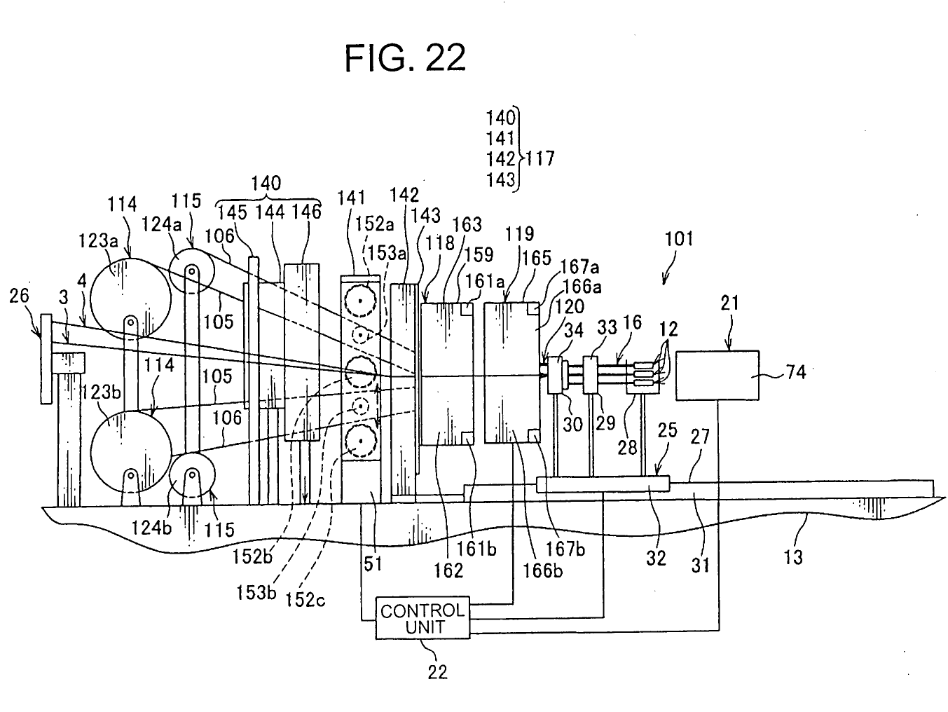

The shield harness manufacturing device and method according to the second embodiment of the present invention is described with reference to FIGS. 22 to 37.

As has been discussed in detail, in the first embodiment, when the ALS sheet 5 is wound around the wire bundle including the plurality of covered wires 3 and the one drain wire 4, then the ALS-wound wire bundle is wrapped in the PET sheet 6 over the entire length of the ALS-wound wire bundle. Also, the one edge 6a and the other edge 6b widthwise of the PET sheet 6 are brought into contact with each other over the entire length, and the one edge 6a and the other edge 6b of the PET sheet 6 are joined together by welding over its entire length.

In the second embodiment, in contrast, the covered wires 3 and the drain wire 4 is wrapped in two ALS sheets 105 opposed to each other. In addition, two PET sheets 106 opposed to each other sandwich therebetween the covered wires 3, the drain wire 4, and the ALS sheets 105. The one end 106a widthwise of the one PET sheet 105 is welded with the one end 106a of the other PET sheet 106 over the entire lengths of the PET sheets 106. Likewise, the other edge 106b width wise of the other PET sheet 106 is welded with the other edge 106b of the other PET sheet 106 over the entire length of the PET sheets 106. It should be noted that the constituent parts and components that have already appeared in the description of the first embodiment are indicated by the same reference numerals as in the first embodiment and the second embodiment will not reiterate their constructions and arrangements that have already been exhaustively discussed in the previous embodiment.

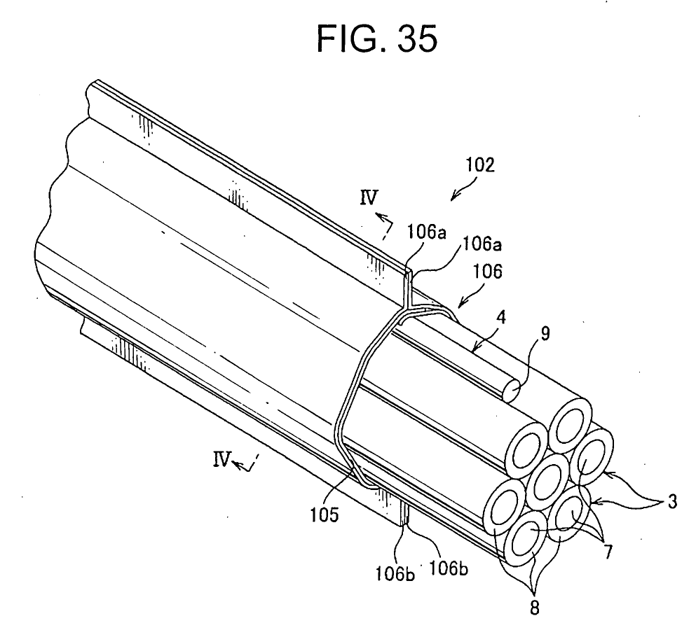

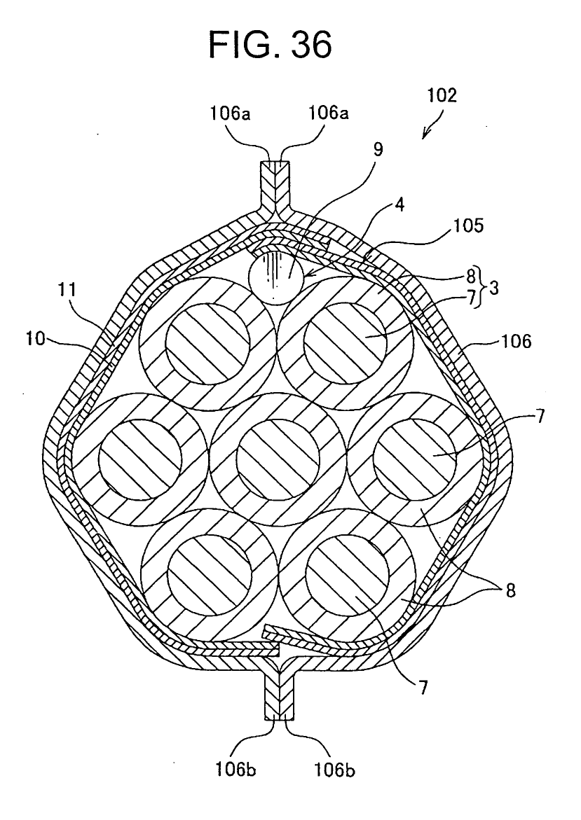

A manufacturing device 101 shown in FIG. 22 is an apparatus that manufactures a shield harness 102 shown in FIGS. 35 and 36. The shield harness 102, as shown in FIGS. 35 and 36, has the plurality of covered wires 3 and the one drain wire 4, and the two electrically conductive ALS sheets 105 and two electrically insulating PET sheets 106.

The ALS sheets 105 each have the thin conductive layer 10 and the insulating layer 11 laminated onto the conductive layer 10. The two ALS sheets 105 are formed in a shape of a strip. The bundle of the covered wires 3 and the drain wire 4 are wrapped in the ALS sheets 105 with the conductive layer 10 coming radially inward of the wire bundle. As shown in FIG. 36, the conductive layer 10 of the ALS sheet 105 remains in contact with the drain wire 4 at least at one peripheral region of the shield harness 102.

The PET sheet 106 is made of flexible and electrically insulating synthetic resin such as polyethylene terephthalate, and formed in a shape of a relatively thin sheet. The two PET sheets 106 are both formed in a shape of a strip.

The shield harness 102 is manufactured by (a) binding the plurality of covered wires 3 and the drain wire 4 into a wire bundle, (b) wrapping the wire bundle constituted by the covered wires 3 and the drain wire 4 in the ALS sheets 105 with its conductive layer 10 coming radially inward of the wire bundle, and then (c) wrapping the ALS-wrapped wire bundle in the PET sheet 106 over the entire length of the ALS-wrapped wire bundle. In the finished shield harness 102, lengths of the ALS sheets 105 and the PET sheets 106 are parallel to the length of the wire bundle.

The two ALS sheets 105 are arranged so as to be opposed to each other, and wound around the wire bundle. The two PET sheets 106 (i.e., the first PET sheet and the second PET sheet) sandwich therebetween the ALS-wrapped wire bundle. The one edge 106a of the one PET sheet 106 and the one edge 106a of the other PET sheet 106 are welded together over the entire lengths of the PET sheets 106. Likewise, the other edge 106b of the one PET sheet 106 and the other edge 106b of the other PET sheet 106 are welded together over the entire lengths.

Note that, in the same manner as in the first embodiment, the term “wire bundle” only denotes a set or a totality of the electrical wires including the covered wire 3 and the drain wire 4, and the term “bundle” does in no way necessitate use of a tape or other bundling means that is provided around a portion of the set of the wires.

Referring to FIG. 22, the manufacturing device 101 has the body 13 and two ALS feeders 114, two PET feeders 115, the electrical-wire-holding unit 16, a guide unit 117, a conductor-winding unit 118, an insulator-winding unit 119, a fixed unit 120, the movable unit 21, and the control unit 22.

The ALS feeders 114 and the PET feeders 115 are provided on and rotatably supported by the flat upper surface of the body 13 of the manufacturing device 101. One of the two ALS feeders 114 has a reel 123a and the other ALS feeder a reel 123b, around which the ALS sheet 105 in a shape of an elongated strip is wound. One of the two PET feeders 115 has a reel 124a and the other PET feeder 115 a reel 124b, around which the PET sheet 106 in a shape of an elongated strip is wound.

The reels 123a and 123b around which the ALS sheets 105 are wound are arranged such that the plurality of covered wires 3 and the drain wire 4 are sandwiched between the two ALS sheets 105. Also, the reel 123a is provided above the reel 123b in a vertical direction. The other reel 123a is provided higher in the vertical direction than the rotatable holding unit 26 that holds the plurality of covered wires 3 and the drain wire 4. The other reel 123b is provided lower in the vertical direction than the rotatable holding unit 26.

The reels 124a and 124b around which the PET sheets 106 are wound are arranged such that the ALS sheets 105 sandwiching the plurality of covered wires 3 and the drain wire 4 are further sandwiched by the two PET sheets 106. Also, the reel 124a is provided above the reel 124b in the vertical direction. The one reel 124a is provided higher than the reel 123a around which the ALS sheet 105 is wound. The other reel 124b is lower in the vertical direction than the reel 123b around which the ALS sheet 105 is wound.

Referring to FIG. 22, the guide unit 117 has a fixed guide 140, a sheet feeder 141, a multiple-component-type guide 142, and a sliding blade 143. The guide unit 117 is provided near the feeders 114, 115 and between the feeders 114,115 and the movable holding unit 25. The fixed guide 140 is provided near the feeders 114, 115 and includes an ALS-guide 144, a first PET-guide 145, and a second PET-guide 146.

The ALS-guide 144, the first PET-guide 145, and the second PET-guide 146 are mounted on the body 13 of the manufacturing device 101. The ALS-guide 144 is a rectangle whose length is parallel to a longitudinal direction of the body 13.

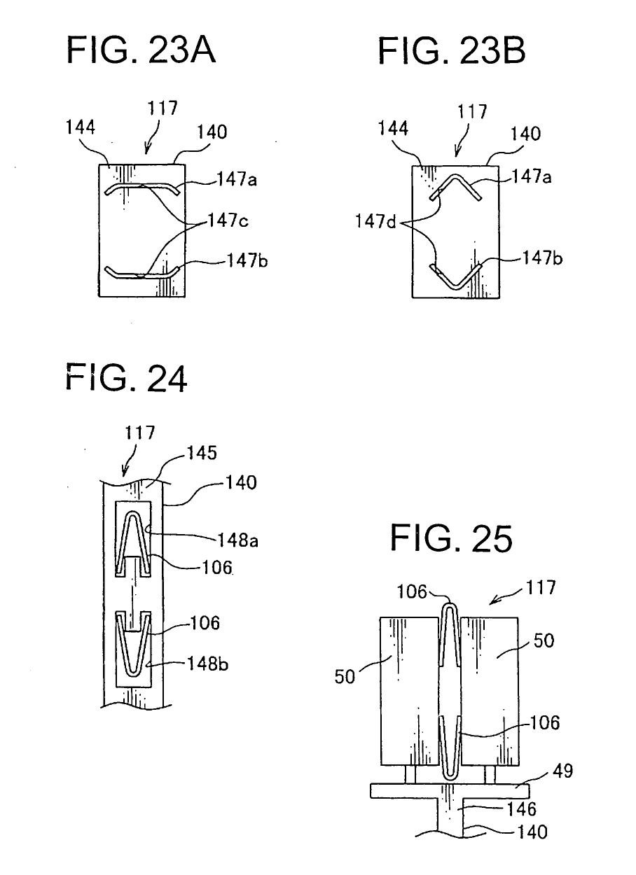

Referring to FIGS. 23A and 23B, the ALS-guide 144 has a pair of guide holes 147a and 147b that extends through the ALS-guide 144 over its length, and inside of which the two the ALS sheets 105 can be passed through the guide holes 147a and 147b, respectively. The pair of guide holes 147a and 147b are spaced from each other in the vertical direction of the ALS-guide 144 and formed parallel to each other. The pair of guide holes 147a, 147b have a U-shaped cross-section that becomes gradually more acute-angled from the side of the feeders 114 and 115 toward the side of the movable holding unit 25. This means that the opening 147d (shown in FIG. 23B) facing the movable holding unit 25 is more acute-angled than the opening 147c (shown in FIG. 23A) facing the feeders 114 and 115 of the guide hole 147a and 147b. Thereafter, the U-shaped openings 147c of the guide holes 147a, 147b are opposed to each other, and the V-shaped openings 147d are likewise opposed to each other.

Referring to FIG. 24, the first PET-guide 145 is formed in a shape of a bar. The first PET-guide 145 has a pair of guide holes 148a and 148b thorough which the PET sheet 106 is passed. The pair of guide holes 148a and 148b are spaced from each other and in parallel with each other in the vertical direction of the first PET-guide 145. The guide holes 148a and 148b of the first PET-guides 145 makes the PET sheet 106 take a V-shaped cross-section. Each end of the two PET sheets 106 with the V-shaped cross-section are arranged in the vertical direction of the first PET-guide 145 mutually closing in the feeding direction of the PET sheets.

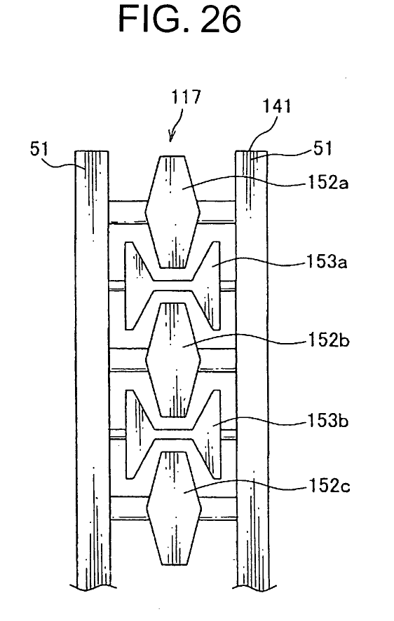

Referring to FIG. 25, the second PET-guide 146 is provided near the first PET-guide 145 and closer to the movable holding unit 25 than the first PET-guide 145 is. The second PET-guide 146 includes the body 49 secured to the body 13 of the manufacturing device 101 and the pair of guide rollers 50. The body 49 has a flat upper surface. The pair of guide rollers 50 are spaced from each other such that a space is provided between their outer surfaces. The guide rollers 50 are rotatably provided on the body 49. The second PET-guide 146 positions the two Pet sheets 106 between the pair of guide rollers 50 and makes the PET sheets 106 take a V-shaped cross-section. The two PET sheets 106 with the V-shaped cross-section come close to each other in the feeding direction of the PET sheets 106.

The sheet feeder 141 is provided near the guides 144, 145, and 146 and closer to the movable holding unit 25 than the guides 144, 145, and 146. As shown in FIG. 26, the sheet feeder 141 has the pair of base plates 51, three fixed pulleys 152a, 152b, and 152c, and two movable pulleys 153a and 153b.

The pair of base plates 51 upstand from the body 13 of the manufacturing device 101 and are arranged in parallel with and spaced from each other in the width direction of the body 13. The three fixed pulleys 152a, 152b, and 152c are arranged between the pair of base plates 51 and are spaced from each other in the vertical direction. The movable pulley 153a is provided between the fixed pulleys 152a and 152b so as to be rotatable between the base plates 51. Also, the movable pulley 153b is provided between the fixed pulleys 152b and 152c so as to be rotatable between the base plates 51. The movable pulley 153a is provided higher in the vertical direction than the movable pulley 153b.

The movable pulley 153a can be moved close to and away from the fixed pulleys 152a and 152b. Likewise, the movable pulley 153b can be moved close to and away from the fixed pulleys 152b and 152c. The movable pulleys 153a and 153b are driven by a motor (not shown).

When the movable pulley 153a of the sheet feeder 141 is driven by the motor and moved close to the fixed pulley 152a of the sheet feeder 141, the ALS sheet 105 or the PET sheet 106 are sandwiched between the movable pulley 153a and the fixed pulley 152a, and the ALS sheet 105 or the PET sheet 106 is further fed toward the movable holding unit 25. In the attached drawings, the PET sheet 106 is fed when the movable pulley 153a is moved close to the fixed pulley 152a, and the ALS sheet 105 is fed when the movable pulley 153a is moved close to the fixed pulley 152b. Also, the PET sheet 106 is fed when the movable pulley 153b is moved close to the fixed pulley 152c, and the ALS sheet 105 is fed when the movable pulley 153b is moved close to the fixed pulley 152b.

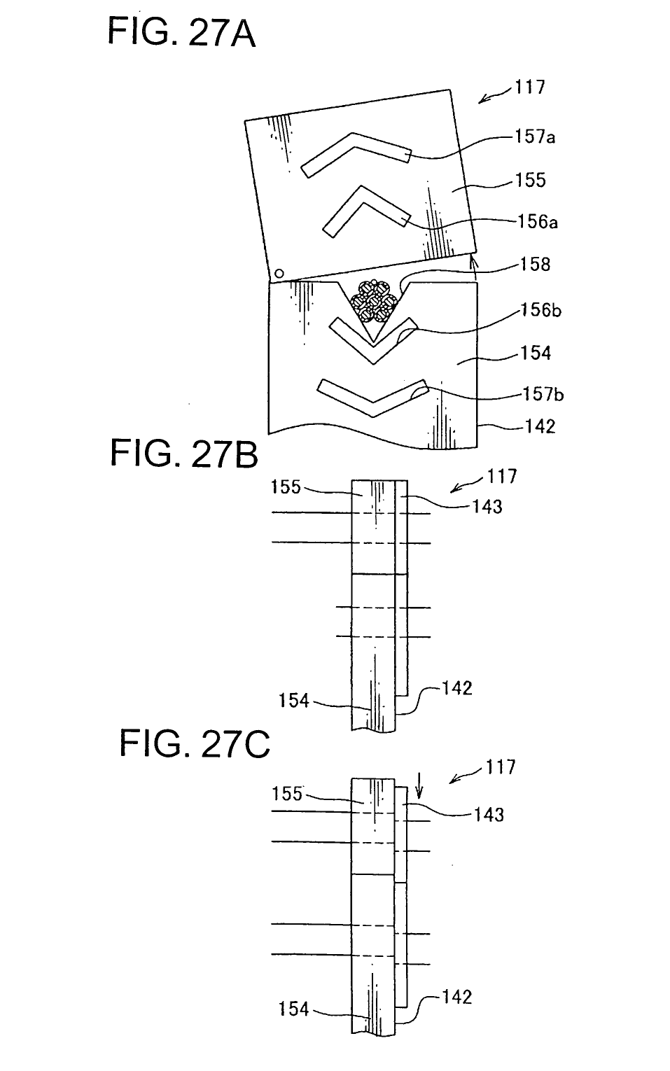

Referring to FIG. 27A, the multiple-component-type guide 142 is provided near the sheet feeder 141 and closer to the movable holding unit 25 than the sheet feeder 141 is. The multiple-component-type guide 142 includes a lower guide portion 154 and an upper guide portion 155.

The lower guide portion 154 is formed in a shape of a quadratic prism upstanding from the body 13 of the manufacturing device 101. The lower guide portion 154 has an ALS-guide hole 156b and a PET-guide hole 157b that are formed therethrough. The ALS-guide hole 156b is provided higher than the PET-guide hole 157b in the vertical direction of the lower guide portion 154. The ALS-guide hole 156b extends through the lower guide portion 154 in the longitudinal direction of the body 13. The ALS-guide hole 156b has a V-shaped cross-section. The ALS sheet 105 is passed through the ALS-guide hole 156b.

The PET-guide hole 157b is provided at a lower portion of the lower guide portion 154 in the vertical direction. The PET-guide hole 157b extends through the lower guide portion 154 in the longitudinal direction of the body 13 of the manufacturing device 101. The PET-guide hole 157b is provided lower than the ALS-guide hole 156b in the vertical direction of the lower guide portion 154. The PET-guide hole 157b has a V-shaped cross-section. The valley of the PET-guide hole 157b is less acute-angled than that of the ALS-guide hole 156b. The PET sheet 106 is passed through the PET-guide hole 157b.

Further, an electrical-wire-guiding groove 158 is formed concave from the upper surface of the lower guide portion 154 in the vertical direction and, in other words, at the central portion of the multiple-component-type guide 142. The electrical-wire-guiding groove 158 is formed concave from the upper surface of the lower guide portion 154 and extends straight in the longitudinal direction of the body 13 of the manufacturing device 101. The electrical-wire-guiding groove 158 has a V-shaped cross-section. The valley of the electrical-wire-guiding groove 158 is more acute-angled than the PET-guide hole 157b and therefore the ALS-guide hole 156b. The covered wires 3 and the drain wire 4 are passed through the electrical-wire-guiding groove 158.

The upper guide portion 155 is formed in a shape of a quadratic prism. The upper guide portion 155 is provided at an edge of the upper surface of the lower guide portion 154 so as to be movable between a position the upward opening of the electrical-wire-guiding groove 158 is closed and a position where the electrical-wire-guiding groove 158 is left open.

The ALS-guide hole 156a and the PET-guide hole 157a extend through the upper guide portion 155. The When the upper guide portion 155 is placed in the position where the opening of the electrical-wire-guiding groove 158 is closed, the ALS-guide hole 156a is found lower than the PET-guide hole 157a in the vertical direction of the upper guide portion 155. The ALS-guide hole 156a extends through the upper guide portion 155 in the longitudinal direction of the body 13 of the manufacturing device 101. The ALS-guide hole 156a has a V-shaped cross-section. In a state where the opening of the electrical-wire-guiding groove 158 is closed by the upper guide portion 155, the ALS-guide holes 156a and 156b having the V-shaped cross-section gradually come close to each other in the longitudinal direction of the body 13 of the manufacturing device 101. The ALS sheet 105 is passed through the ALS-guide hole 156a.

In the state where the opening of the electrical-wire-guiding groove 158 is closed by the upper guide portion 155, the PET-guide hole 157a is found higher than the ALS-guide hole 156a in the vertical direction of the upper guide portion 155. The PET-guide hole 157a extends through the upper guide portion 155 in the longitudinal direction of the body 13 of the manufacturing device. 101. The PET-guide hole 157a has a V-shaped cross-section. The valley of the PET-guide hole 157a is less acute-angled than that of the ALS-guide hole 156a. In the state where the opening of the electrical-wire-guiding groove 158 is closed by the upper guide portion 155, the PET-guide holes 157a and 157b having the V-shaped cross-section come closer to each other in the longitudinal direction of the body 13 of the manufacturing device 101. The PET sheet 106 is passed through the PET-guide hole 157a.

The sliding blade 143 is formed in a shape of a strip and in contact with the lateral surface of the lower guide portion 154 and the upper guide portion 155 of the multiple-component-type guide 142, the lateral surface being opposed to the movable holding unit 25. The sliding blade 143 can be slid on the lateral surface in the vertical direction. The sliding blade 143 has guide holes (not shown) that register with the ALS-guide holes 156a, 156b and the PET-guide holes 157a, 157b. The ALS sheet 105 and the PET sheet 106 are passed through the guide holes. When the sliding blade 143 is slid on the lateral surface of the lower guide portion 154 and the upper guide portion 155 in the vertical direction, the ALS sheet 105 and the PET sheet 106 are cut by the sliding blade 143 on the lateral surface of the lower guide portion 154 and the upper guide portion 155.

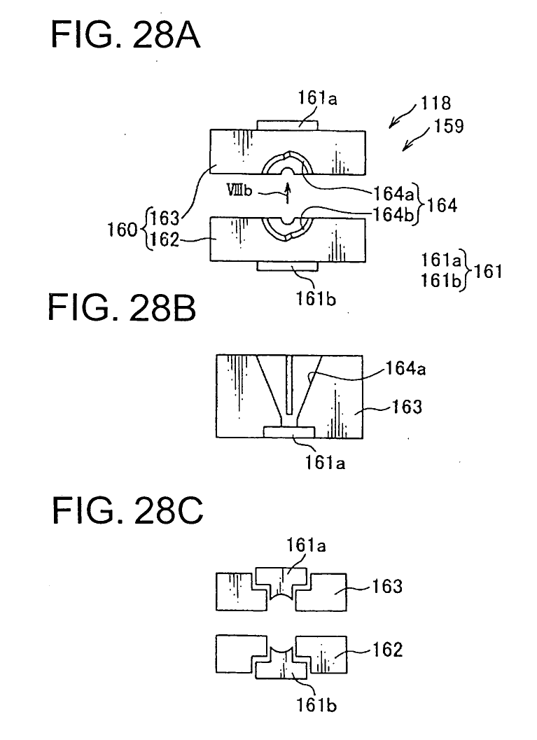

The conductor-winding unit 118 is provided near the multiple-component-type guide 142 and closer to the movable holding unit 25 than the multiple-component-type guide 142 is. As shown in FIG. 22, the conductor-winding unit 118 has a conductor-winding mold 159 and a shifting unit (not shown). Referring to FIG. 28A, the conductor-winding mold 159 has a main mold 160 and a pair of fastening molds 161. The main mold 160 includes a lower mold 162 and an upper mold 163 that are each formed in a thick flat plate. The lower mold 162 and the upper mold 163 ca be moved close to and away from each other such that an upper surface of the lower mold 162 can be brought into contact with the lower surface of the upper mold 163 in the vertical direction.

The lower mold 162 is provided lower than the upper mold 163 in the vertical direction of the main mold 160. The lower mold 162 has a groove 164b formed concave on the upper surface of the lower mold 162. Likewise; the upper mold 163 has a groove 164a formed concave on the lower surface of the upper mold 163. The grooves 164a and 164b have an arc-shaped cross-section. In a state where the lower mold 162 and the upper mold 163 are in direct contact with each other, the grooves 164a and 164b register with each other to constitute a through-hole 164. Also, in t he state where the lower mold 162 and the upper mold 163 are in direct contact with each other, a diameter of the through-hole 164 gradually decreases from the side of the multiple-component-type guide 142 toward the movable holding unit 25. With the lower mold 162 and the upper mold 163 moved close to each other, the covered wires 3, the drain wire 4, and the two ALS sheets 105 placed at the periphery of these wires are passed through the through-hole 164, so that the covered wire 3 is wrapped in the ALS sheets 105.

Referring to FIG. 28B, the pair of fastening molds 161 are provided at proximal edges of the upper mold 163 and the lower mold 162 of the main mold 160, respectively, the edges being proximal when viewed from the movable holding unit 25. In other words, the fastening molds 161 are provided at the downstream edges of the upper mold 163 and the lower mold 162, the edges being downstream in the feeding direction of the ALS sheet 105 and the PET sheet 106 by the sheet feeder 141. The one fastening mold 161a of the pair of fastening mold 161 are provided on the upper mold 163 of the main mold 160 slidably in the vertical direction. Likewise, the other fastening mold 161b of the pair of fastening mold 161 is provided on the lower mold 162 of the main mold 160 slidably in the vertical direction. The fastening molds 161a and 161b are slid close to each other, so that the covered wires 3, the drain wire 4, and the two ALS sheets 105 wound around the wires are pressed by the fastening molds 161a and 161b.

The cylinder unit moves the molds 161a, 161b, 162, and 163 in the vertical direction so that the molds 161a, 161b, 162, and 163 are moved close to and away from each other.

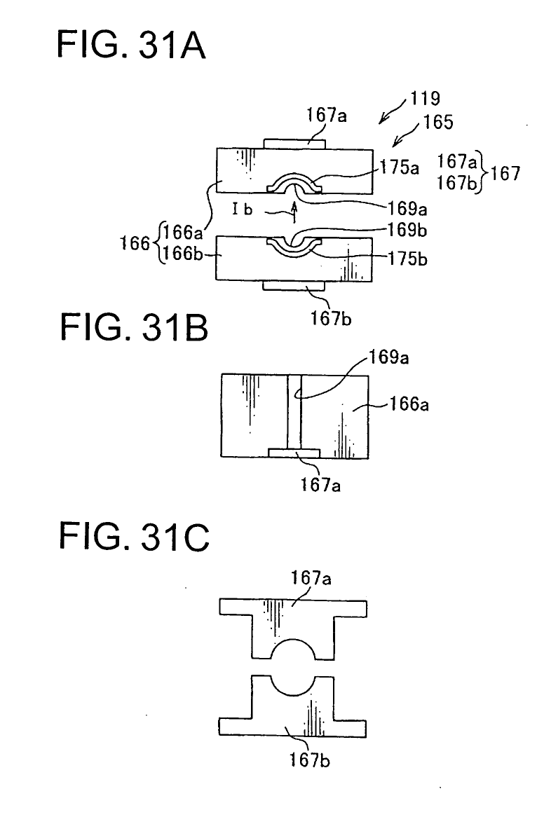

Referring to FIG. 22, the insulator-winding unit 119 is provided near the conductor-winding unit 118 and closer to the movable holding unit 25 than the conductor-winding unit 118 is. The insulator-winding unit 119 has an insulator-winding mold 165 and a shifting unit (not shown). Referring further to FIG. 31A, the insulator-winding mold 165 has a main mold 166 and a pair of clamping molds 167.

The main mold 166 includes a lower mold 166b and an upper mold 166a that are formed in a shape of a thick flat plate. An upper surface of the lower mold 166b can be brought into direct contact with the lower surface of the upper mold 166a in the vertical direction. Also, the lower mold 166b and the upper mold 166a can be moved close to and away from each other.

The lower mold 166b is provided lower than the upper mold 166a in the vertical direction of the main mold 166. The lower mold 166b has a through-hole 175b. The ALS-wrapped wire bundle (i.e., the covered wires 3, the drain wire 4, and the ALS sheets 105 wrapping these wires) and the PET sheets 106 placed at the periphery of the ALS-wrapped wire bundle are passed through the through-hole 175b. The through-hole 175b extends in the longitudinal direction of the body 13 of the manufacturing device 101. The through-hole 175b has a substantially U-shaped cross-section. The through-hole 175b extend in a linear manner.

Also, the lower mold 166b has a guide groove 169b formed concave on the upper surface of the lower mold 166b facing the lower surface of the upper mold 166a. The guide groove 169b extends straight in the longitudinal direction of the body 13 of the manufacturing device 101.

The upper mold 166a has a through-hole 175a. The ALS-wrapped wire bundle and the PET sheets 106 placed at the periphery of the ALS-wrapped wire bundle are passed through the through-hole 175a. The through-hole 175a extends in the longitudinal direction of the body 13 of the manufacturing device 101. The through-hole 175a has a substantially U-shaped cross-section. The through-hole 175a extends in a linear fashion such that ends of the through-holes 175a and 175b gradually becomes close to each other.

Also, the upper mold 166a has a guide groove 169a formed concave on the lower surface of the upper mold 166a facing the upper surface of the lower mold 166b. The guide groove 169a extends straight in the longitudinal direction of the body 13 of the manufacturing device 101. In a state where the lower mold 166b and the upper mold 166a are in direct contact with each other with the guide grooves 169b and 169b registering with each other, the covered wires 3, the drain wire 4, and the ALS sheets 105 wrapping these wires are passed through the guide grooves 169b and 169b.

Referring to FIG. 31B, the pair of clamping molds 167 are provided at proximal edges of the upper mold 166a and the lower mold 166b of the main mold 166, the edges being proximal when viewed from the movable holding unit 25. In other words, the pair of clamping molds 167 are provided at the downstream edges of the upper mold 166a and the lower mold 166b of the main mold 166, the edges being downstream in the feeding direction of the ALS sheets 105 and the PET sheets 106 by the sheet feeder 141. The one clamping mold 167a of the pair of clamping molds 167 is provided on the upper mold 166a of the main mold 166 slidably in the vertical direction. Likewise, the other clamping mold 167b of the pair of clamping mold 167 is provided on the lower mold 166b of the main mold 166 slidably in the vertical direction. The clamping molds 167a and 167b are slid close to each other, so that the ALS-wrapped wire bundle and the two PET sheets 106 placed at the periphery of the ALS-wrapped wire bundle is pressed by the clamping molds 167a and 167b.

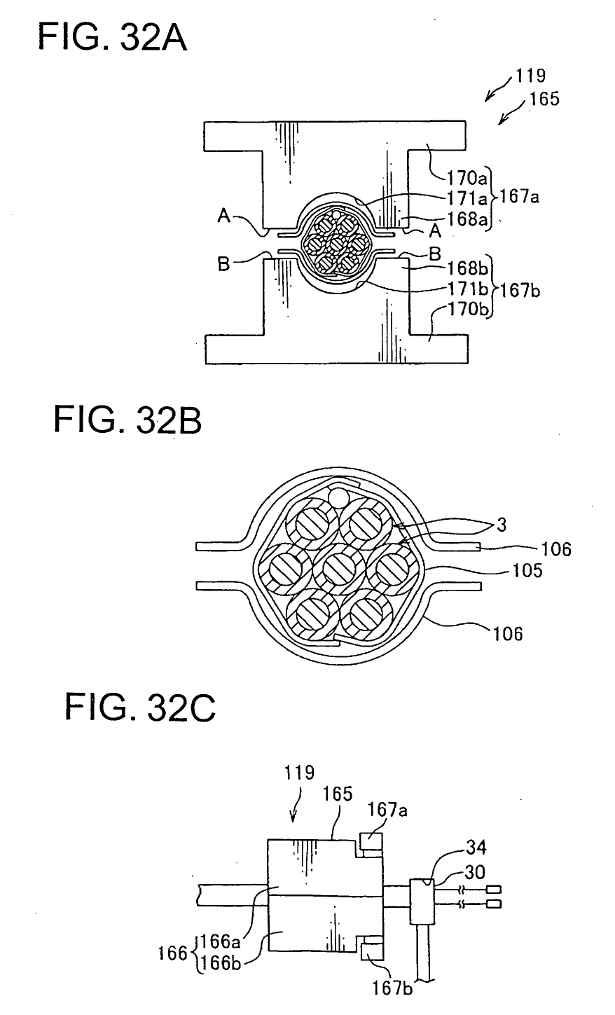

Referring to FIG. 32, the clamping mold 167b is mounted on the lower mold 166b. The clamping mold 167b has a body 170b formed in a shape of a thick flat plate, a clamping portion 168b formed concave on the surface of the body 170b, and a wire-rest portion 171b that can be brought into close contact with the clamping portion 168b and the clamping portion 168a and is formed concave on the flat surface B. The wire-rest portion 171b extends in a linear fashion in the longitudinal direction of the body 13 of the manufacturing device 101 and over the entire length of the body 170b. The exposed surface of the wire-rest portion 171b has a cross-section in a shape of an arc.

The clamping mold 167a is mounted on the upper mold 166a. As shown in FIG. 32, the clamping mold 167a includes a body 170a formed in a shape of a thick flat plate, a clamping portion 168a formed concave on the surface of the body 170a, and the wire-rest portion 171a that can be brought into close contact with the clamping portion 168b and the clamping portion 168a and is formed concave on the flat surface A. The surface A is a flat surface. The wire-rest portion 171a extends in a linear fashion in the longitudinal direction of the body 13 of the manufacturing device 101 and over the entire length of the body 170a. The exposed surface of the wire-rest portion 171a is formed in a shape of an arc.

The ALS-wrapped wire bundle and the PET sheet 106 placed at the periphery of the ALS-wrapped wire bundle is positioned between the exposed surfaces of the wire-rest portions 171a and 171b. When the clamping molds 167a and 167b are moved close to each other, the main mold 166 makes the ALS-wrapped wire bundle and the PET sheets 106 at the periphery thereof take a U-shaped cross section. The edges of the two PET sheets 106 with the U-shaped cross-section is arranged such that the edges can be moved close to each other.

When sandwiched between the surfaces A and B of the clamping portions 168a and 168b, the one edge 106a widthwise of the one PET sheet 106 of the overlaps with the one edge 106a of the other PET sheet 106, and likewise the other edge 106b of the one PET sheet 106 overlaps with the other edge 106b of the other PET sheet 106.

The shifting unit is operable to move the upper mold 166a and the lower mold 166b of the main mold 166 integrally in the width direction of the body 13 of the manufacturing device 101, so that the upper mold 166a and the lower mold 166b are moved in the longitudinal direction of the body 13 between a position where the upper mold 166a and the lower mold 166b are closely aligned with the main mold 160 and the fastening molds 161a, 161b of the conductor-winding unit 118 and a position where they are not closely aligned with these molds.

Also, the shifting unit is operable to raise and lower the upper mold 166a of the main mold 166 and the clamping mold 167a mounted on the upper mold 166a. In addition, the shifting unit is operable to raise and lower the lower mold 166b of the main mold 166 and the clamping mold 167b mounted on the lower mold 166b. Further, the shifting unit is operable to move the clamping mold 167a mounted on the upper mold 166a and the clamping mold 167b mounted on the lower mold 166b close to each other.

The fixed unit 120 is provided near the insulator-winding unit 119 and closer to the movable holding unit 25 than the insulator-winding unit 119 is. In the second embodiment, two fixed units 120 are provided.

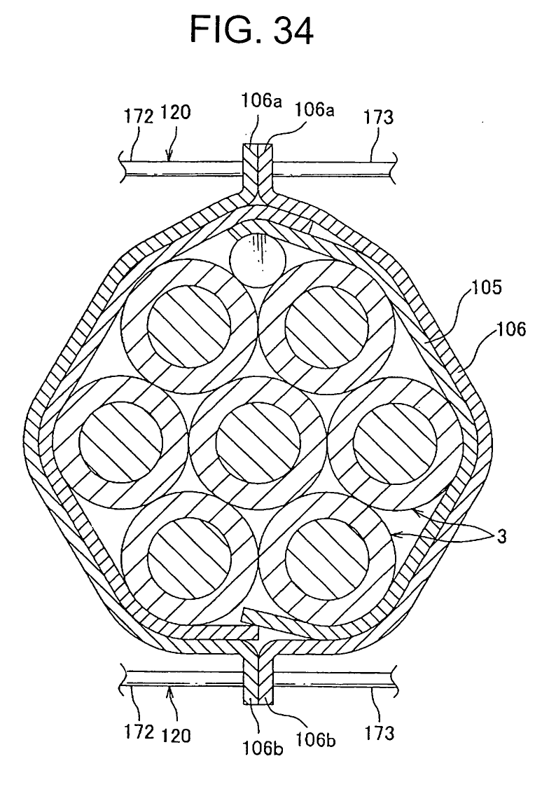

Referring to FIG. 34, the fixed unit 120 has a horn 172 and an anvil 173 that are moved close to and away from each other, a piezoelectric vibrator (not shown) that places the horn 172 under ultrasonic vibration, and a cylinder unit (not shown) that moves the horn 172 and the anvil 173 close to and away from each other.

The horn 172 and the anvil 173 are spaced from each other in the width direction of the body 13 of the manufacturing device 101. The horn 172 and the anvil 173 are formed in a shape of a strip whose length is parallel to the width of the body 13. The piezoelectric vibrator makes the horn 172 vibrate with small amplitude at a frequency of for example 20 KHz.

The pair of fixed units 120 (its cylinder unit, to be more specific) moves the horn 172 and the anvil 173 close to each other so that The two PET sheets 106 [symbol] width direction [symbol] one edge 106a of the one PET sheet 106 overlaps with the one edge 106a of the other PET sheet 106 and likewise the other edge 106b of the one PET sheet 106 is overlapped with the other edge 106b of the other PET sheet 106, and the one edges 106a are clamped between the horn 172 and the anvil 173 of the one fixed unit 120 and the other edges 106b are clamped between the horn 172 and the anvil 173 of the other fixed unit 120. After that, when the piezoelectric vibrator places the horn 172 under ultrasonic vibration, frictional heat occurs at the one edges 106a and the other edges 106b of the PET sheets 106 and by virtue of the frictional heat, the one edges 106a of the two PET sheets 106 are welded together and likewise the other edges 106b of the two Pet sheets 106 are welded together. Welded portions W, which have been achieved by welding the mating edges of the PET sheets, are provided uninterruptedly over the entire length of the covered wires 3, the drain wire 4, the ALS sheets 105, and the PET sheets 106.

Having fully described the construction and arrangement of the manufacturing device 101 according to the second embodiment, the following describes how the shield harness 102 is manufactured by the manufacturing device 101 by applying first the two ALS sheet 105 and then the two PET sheets 106 around the covered wires 3 and the drain wire 4 that are cut in the predetermined length with the terminal fittings 12 attached to the both ends thereof.

As preparatory operation, the terminal fitting 12 has to be attached to one end of the covered wires 3 and the drain wire 4. Then the covered wires 3 and the drain wire 4 are hooked onto the terminal holder 28 of the movable holding unit 25 of the electrical-wire-holding unit 16, and then the one end of the covered wires 3 and the drain wire 4 is held by the terminal holder 28. Meanwhile, the other end of the covered wire 3 is inserted into the electrical-wire-holding slit 38 of the driven gear 37 of the rotatable holding unit 26 such that the other end of the covered wires 3 are held. Likewise, the other end of the drain wire 4 is inserted into the drain-wire-holding slit 39 of the driven gear 37 of the rotatable holding unit 26 so that the other end is held. Further, the central portion of the covered wires 3 and the drain wire 4 is received in the electrical-wire-guiding groove 158 of the multiple-component-type guide 142 of the guide unit 117, and the opening of the electrical-wire-guiding groove 158 is closed by the cover 155.

Further, the tip of the ALS sheet 105 wound around the reel 123a of the ALS feeder 114 is passed through the guide hole 147a of the ALS-guide 144 of the fixed guide 140 of the guide unit 117 and then between the fixed pulley 152a and the movable pulley 153a of the sheet feeder 141, and further into the ALS-guide hole 156a formed on the upper guide portion 155 of the multiple-component-type guide 142 so as to be in contact with the sliding blade 143.

Likewise, the tip of the ALS sheet 105 wound around the reel 123b of the ALS feeder 114 is passed through the guide hole 147b of the ALS-guide 144 of the fixed guide 140 of the guide unit 117 and then between the fixed pulley 152b and the movable pulley 153b of the sheet feeder 141, and further into the ALS-guide hole 156b formed on the lower guide portion 154 of the multiple-component-type guide 142 so as to be in contact with the sliding blade 143.

Also, the tip of the PET sheet 6 wound around the reel 124a of the PET feeder 115 is passed (in order of appearance below) through the guide hole 148a of the first PET-guide 145 of the fixed guide 40 of the guide unit 117, between the guide rollers 50 of the second PET-guide 146, and between the fixed pulley 152a provided at a lower portion of the sheet feeder 141 and the movable pulley 153a of the sheet feeder 141. The tip of the PET sheet 6 is inserted into the PET-guide hole 157a provided on the upper guide portion 155 of the multiple-component-type guide 142 so as to be in contact with the sliding blade 143.

Likewise, the tip of the PET sheet 6 wound around the reel 124b of the PET feeder 115 is passed (in order of appearance below) through the guide hole 148b of the first PET-guide 145 of the fixed guide 140 of the guide unit 117, between the guide rollers 50 of the second PET-guide 146, and between the fixed pulley 152b provided at a lower portion of the sheet feeder 141 and the movable pulley 153b of the sheet feeder 141. The tip of the PET sheet 6 is inserted into the PET-guide hole 157b provided on the lower guide portion 154 of the multiple-component-type guide 142 so as to be in contact with the sliding blade 143.

Upon completion of the preparatory operation, the manufacturing device 101 is now ready to start manufacturing operation.

First, the movable pulleys 153a and 153b are moved close to the fixed pulley 152b of the sheet feeder 141 of the guide unit 117. Then the two ALS sheets 105 are sandwiched between the pulleys 152b, 153a and pulleys 152b, 153b, respectively.

The sliding blade 143 is placed at a position where the guide holes of the sliding blade 143 register with and communicate with the guide holes 156a, 156b, 157a, and 157b of the multiple-component-type guide 142 (shown in FIG. 27B).

The main mold 66 and the pair of clamping molds 167a, 167b of the insulator-winding unit 119 are placed all together at a position where they are not closely aligned with the conductor-winding unit 118 in the longitudinal direction of the body 13 of the manufacturing device 101. As shown in FIG. 31A, the upper mold 166a of the main mold 166 of the insulator-winding unit 119 and the clamping mold 167a mounted on the upper mold 166a are raised integrally, and the lower mold 166b and the clamping mold 167b mounted on the lower mold 166b are lowered integrally.

The slider 32 of the movable holding unit 25 (and accordingly the terminal holder 28, the electrical-wire-chuck portion 29, and the sheet-chuck portion 30) are placed most proximate to the conductor-winding unit 118, and the pair of chuck members 33 of the electrical-wire-chuck portion 29 are moved close to each other, so that the covered wires 3 and the drain wire 4 are sandwiched between them. Further, the pair of chuck members 34 of the sheet-chuck portion 30 are spaced from each other. The pair of belt units 74 of the movable unit 21 are also spaced from each other. The horn 172 and the anvil 173 of the one fixed unit 120 are spaced from each other. Likewise, the horn 172 and the anvil 173 of the other fixed unit 120 are spaced from each other.

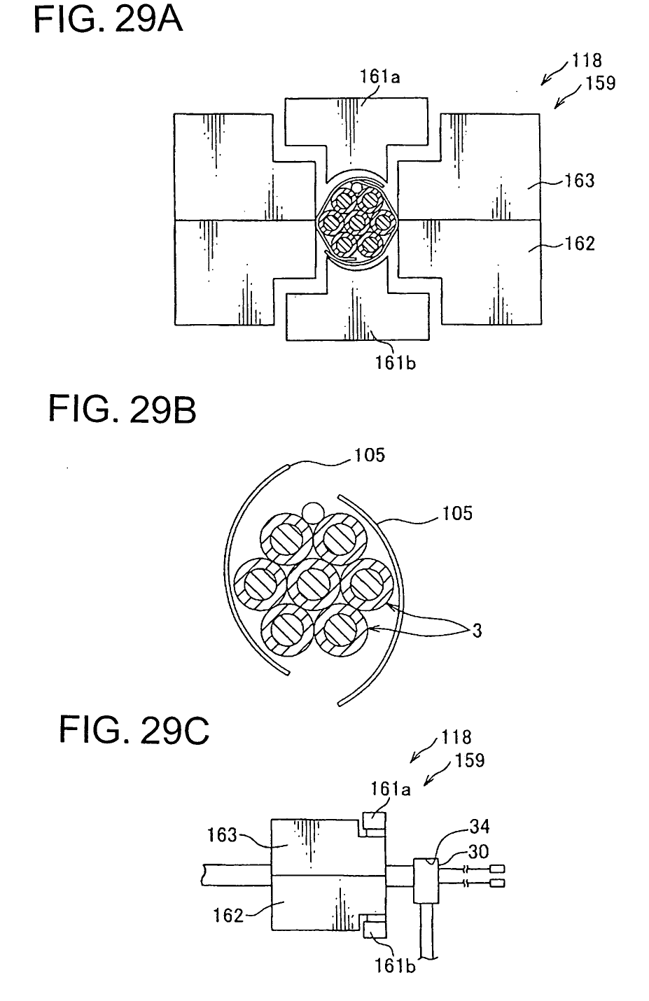

Thereafter, as shown in FIGS. 29A and 29C, the upper mold 163 and the lower mold 162 of the conductor-winding unit 118 are closely overlapped with each other, so that the covered wires 3 and the drain wire 4 are sandwiched between the lower molds 162 and the upper mold 163. Also, the covered wires 3 and the drain wire 4 are passed through the conductor-winding mold 159.

After that, the motor (not shown) drives and rotates the movable pulleys 153a, 153b of the sheet feeder 141, so that the ALS sheets 105 opposed to each other are fed into the through-hole 164 of the main mold 160 of the conductor-winding mold 159 of the conductor-winding unit 118. Since the diameter of the through-hole 164 gradually decreases toward the side of movable holding unit 25, the ALS sheets 105 are guided by the inner surface of the through-hole 164 (see FIG. 29B), and gradually applied around the wire bundle (i.e., the covered wires 3 and the drain wire 4).

When the tip of the ALS sheet 105 is passed thorough the through-hole 164 and placed between the pair of chuck members 34 of the sheet-chuck portion 30, the movable pulleys 153a and 153b of the sheet feeder 141 stop rotating. The pair of chuck members 34 of the sheet-chuck portion 30 move close to each other, and thus the tip of the covered wires 3, the drain wire 4, and the ALS sheet 5 is sandwiched between the chuck members 34.

Following this, the fastening mold 161a of the conductor-winding mold 159 is lowered and the tip of the covered wires 3, the drain wire, and the ALS sheet 5 is sandwiched against the fastening molds 161a and 161b. After that, the ALS sheet 105 is applied around the wire bundle such that the wire bundle and the ALS sheet 5 is in intimate contact with each other.

After that, the slider 32 of the movable holding unit 25 (and accordingly the terminal holder 28, the electrical-wire-chuck portion 29, and the sheet-chuck portion 30) is moved away from the conductor-winding unit 118. Further, the insulator-winding mold 165 is moved along with the movable unit 21 of the insulator-winding unit 119, so that the insulator-winding mold 165 is placed at a position where the insulator-winding mold 165 is closely aligned with the conductor-winding mold 159 of the conductor-winding unit 118 in the longitudinal direction of the body 13 of the manufacturing device 101. In this manner, the insulator-winding unit 119 is placed between the conductor-winding unit 118 and the movable holding unit 25. Thereafter, the pair of chuck members 34 of the sheet-chuck portion 30 are moved away from each other. The movable pulley 153a is moved close to the fixed pulley 152, so that the two PET sheets 106 are sandwiched between the pulleys 152a and 153a and between the pulleys 152c and 153b, respectively.

Thereafter, as shown in FIGS. 31A and 31C, the upper mold 166a is closely overlapped with the lower mold 166b. The guide groove 169a of the upper mold 166a registers with the guide groove 169b of the lower mold 166b. The ALS-wrapped wire bundle is received in the through hole defined by the two guide groove 169a, 169b.

After that, the motor (not shown) is rotated and movable pulleys 153a and 153b of the sheet feeder 141. Thereafter, one of the two PET sheets 106 opposed to each other is fed toward the through-hole 175a of the upper mold 166a of the main mold 166 of the insulator-winding mold 165 of the insulator-winding unit 119 shown in FIG. 31A, and the other of the two PET sheets 106 is fed toward the through-hole 175b of the lower mold 166b of the main mold 166 of the insulator-winding mold 165 of the insulator-winding unit 119 shown in FIG. 31A. After that, the through-hole 175a of the upper mold 166a of the main mold 166 makes the one of the two PET sheets 106 take a U-shaped cross-section. Meanwhile, the through-hole 175b of the lower mold 166b of the main mold 166 makes the other of the two PET sheets 106 take a U-shaped cross-section. As shown in FIGS. 32B and 32C, the PET sheets 106 having the U-shaped cross-section are placed at the periphery of the ALS-wrapped wire bundle.

Thereafter, the tip of the PET sheets 106 on the wire-rest portion 171a is passed through the pair of clamping portions 168a and 168b and positioned between the pair of chuck members 34 of the sheet-chuck portion 30. Then the movable pulleys 153a and 153b of the sheet feeder 141 stop rotating, and the pair of chuck members 34 of the sheet-chuck portion 30 are moved close to each other. The tip of the covered wires 3, the drain wire 4, the ALS sheets 105, and the PET sheets 106 are sandwiched between the chuck members 34. Following this, the clamping molds 167a and 167b of the insulator-winding mold 165 are moved close to each other. Thus, one edge 106a and the other edges 106b of the two PET sheets 106 are pressed by the surfaces A and B of the clamping mold 167a and 167b, respectively.

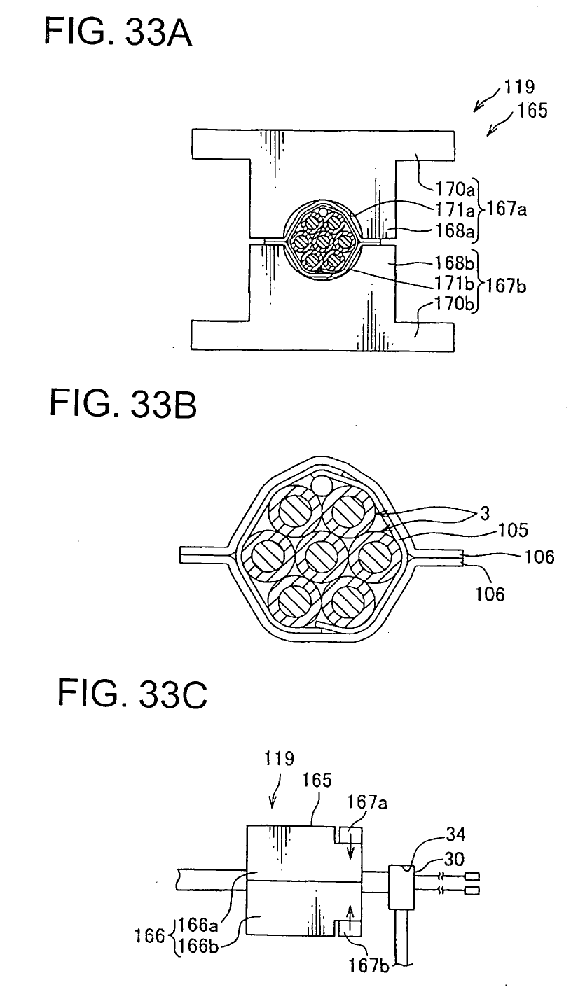

Thereafter, the clamping molds 167a and 167b of the insulator-winding mold 165 are moved close to each other, and, as shown in FIG. 33A, the surfaces A and B of the clamping portions 168a and 168b are, tough not in complete contact, but yet very close to each other with a limited degree of gaps left therebetween. The clamping portions 168a and 168b are very close to each other, and the ALS-wrapped wire bundle is wrapped in the two PET sheets 106, which are now brought into close contact with each other.

Following this, as shown in FIG. 34, the horn 172 and the anvil 173 of one of the two fixed unit 120s are moved close to each other so that the one edge 106a of the one PET sheet 106 and the one edge of the other PET sheet 106 are clamped between the horn 172 and the anvil 173 of the one fixed unit 120 with the horn 172 under ultrasonic vibration by the ultrasonic oscillator. Likewise, the horn 172 and the anvil 173 of the other fixed unit 120 are moved close to each other so that the other edge 106b of the one PET sheet 106 and the other edge of the other PET sheet 106 are clamped between the horn 172 and the anvil 173 of the other fixed unit 120 with the horn 172 under ultrasonic vibration by the ultrasonic oscillator. Then, frictional heat occurs at portions of the one edges 106a and the other edges 106b of the PET sheets 106 that are clamped between the corresponding horn 172 and anvil 173 and, as a result, the edges 106a and 6b of the PET sheets 106 are welded together. Thereafter, the slider 32 of the movable holding unit 25 (and accordingly the terminal holder 28, the electrical-wire-chuck portion 29, and the sheet-chuck portion 30) is moved away from the conductor-winding unit 118. As the movable holding unit 25 is moving, the covered wires 3, the drain wire 4, the ALS sheets 105, and the PET sheets 106 are moved away from the conductor-winding unit 118, and the portions of the one edges 106a and the other edges 106b of the PET sheets 106 that are clamped between the horn 172 and the anvil 173 are also moved, and as a result the one edges 106a and the other edges 106b of the PET sheets 106 are welded in the longitudinal direction in response to movement relative to the conductor-winding unit 118. This means that, as shown in FIG. 36, the one edges 106a in the width direction of the two PET sheets 106 are welded together and likewise the other edges 106b are welded together, so that the welded portions W are provided uninterruptedly over the entire length of the covered wires 3, the drain wire 4, the ALS sheets 105, and the PET sheets 106.

After that, when the slider 32 of the movable holding unit 25 (and accordingly the terminal holder 28, the electrical-wire-chuck portion 29, and the sheet-chuck portion 30) is placed at a position more distant from the rotatable holding unit 26 than the pair of belt units 74 of the movable unit 21 are, then the slider 32 stops moving. Thereafter, the pair of belt units 74 of the movable unit 21 are moved close to each other, so that the PET sheets 106 covering the ALS-wrapped wire bundle is sandwiched between the belt units 74. Also, the pair of chuck members 33 of the electrical-wire-chuck portion 29 are moved away from each other, and the pair of chuck members 34 of the sheet-chuck portion 30 are moved away from each other, and the driving pulley of the belt unit 74 of the movable unit 21 is rotated. Further, the covered wires 3, the drain wire 4, and the ALS sheets 5, and the PET sheets 6 are moved integrally away from the feeders 114 and 115.

Thereafter, when the ALS sheets 105 and the PET sheets 106 are moved for a predetermined distance, as shown in FIG. 27C, the sliding blade 143 slides relative to the multiple-component-type guide 142, and cuts the ALS sheets 105 and the PET sheets 106, and, immediately before sliding of the sliding blade 143 and accordingly immediately before cutting of the ALS sheets 105 and the PET sheets 106, the motor of the rotatable holding unit 26 is driven to cause only one round of rotation of the driven gear 37. After that, since the other end of the drain wire 4 is held at a periphery of the driven gear 37, the drain wire 4 is positioned at a peripheral region of the circular cross section of the wire bundle, and comes into direct contact with the conductive layer 10 of the ALS sheets 5. Thus, the rotatable holding unit 26 of the electrical-wire-holding unit 16 controlled by the control unit 22 causes at least one round of rotation of the driven gear 37.

Following this, the sliding blade 143 slides again, and the sliding blade 143 is placed at a position where the guide holes of the sliding blade 143 register with the ALS-guide holes 156a, 156b, and the PET-guide holes 157a, of the multiple-component-type guide 142, and the endless belt of the belt unit 74 of the movable unit 21 runs so that the ALS-wrapped wire bundle and the PET sheets 106 covering the ALS-wrapped wire bundle are moved to a position more distant from the feeders 114 and 115 than the movable holding unit 25 is.

The manufacturing of the shield harness 102 is thus completed.

The shield harness manufacturing device and the shield harness manufacturing method according to the second embodiment of the present invention have the following advantages.

The conductor-winding mold 159 is provided to apply the ALS sheets 105 around the wire bundle constituted by the covered wires 3 and the drain wire 4, and the insulator-winding mold 165 is provided to apply the PET sheets 106 around the ALS-wrapped wire bundle. Thus, the shield harness 102 is manufactured by wrapping the wire bundle first in the ALS sheets 105 and then in the PET sheets 106 around the bundle of the covered wires 3 and the drain wire 4.

Accordingly, the shield harness 102 can be made more light-weight since the need of covering the external surface of the ALS sheets 105 by an insulating synthetic resin is eliminated. Also, since the PET sheets 106 covers the external surface of the ALS sheets 105, the ALS sheets 105 wound around the wire bundle can be protected against being exposed to an outside, and thus shielding performance of the shield harness 102 can be improved.

Also, the conductor-winding mold 159 wraps the covered wires 3 and the drain wire 4 in the ALS sheet 105. Since the readily-plastically-deformed ALS sheets 105 are wound around the periphery of the wire bundle, the covered wire 3 and the drain wire 4 can be wrapped in the ALS sheets 105 more adhesively and snugly, in stable contact with the electrical wire. Accordingly, the ALS sheet 105 can be effectively wound around the covered wires 3 and the drain wire 4.

Further, the insulator-winding molds 165 sandwiches the ALS sheets 105 therebetween for covering the ALS-wrapped wire bundle by the PET sheet 106. Since the not-readily-plastically-deformed PET sheets 106 are placed such that the wire bundle is sandwiched therebetween, the PET sheets 106 can be applied without causing damage to them. Accordingly, the covered wires 3, the drain wire 4, and the ALS sheet 105 covering the wires can be effectively wrapped in the PET sheet 106.

In addition, since the ends 106a and 106a and 106b, and 106b are welded over the entire length of the two PET sheets 106, adjustment can be readily achieved by shifting the welded portions W of the two PET sheets 106 in the width direction of the PET sheets 106 in response to changes in the number and diameter of the covered wires 3 that are covered by the PET sheet 106.

Also, since the ALS sheets 105 that are wound around the wire bundle by the conductor-winding mold 159 is readily plastically deformed. The ALS sheets 105 can be wound more adhesively and in more stable contact with the covered wire 3 and the drain wire 4. Accordingly, the ALS sheet 5 can be wound around the wire bundle effectively.

Since the covered wires 3, the drain wire 4, and the ALS sheets 105 are inserted into the through-holes 164a, 164b of the main mold 160 of the conductor-winding mold 159, the diameter of the through-holes 164a, 164b gradually decreasing, the ALS sheets 105 can be effectively wound around the wire bundle.

In addition, since the ALS sheets 105 are sandwiched between the fastening molds 161a and 161b, the wound ALS sheets 5 are clamped between the two molds so that the ALS sheets 105 can be snugly wound around the wire bundle.

Since the main mold 166 of the insulator-winding mold 165 holds the PET sheets 106 in such a manner that the cross-section of the PET sheets 106 has an U-shape and the one edge 106a of the one PET sheet 106 and the one edge 106a of the other PET sheet 106 are clamped between the pair of clamping molds 167a and 167b, and likewise the other edge 106b of the other PET sheet 106 and the other edge 106 of the PET sheet 106 are clamped between the pair of clamping molds 167a and 167b, the PET sheets 106 can be effectively wound around the ALS-wrapped wire bundle.

Since the corresponding two each of the edges 106a and 106b of the PET sheets 106 are joined with each other by the fixed unit 120, the corresponding edges of the PET sheets 106 can be joined together with the PET sheets 106 wound around the covered wires 3, the drain wire 4, and the ALS sheets 105.

By virtue of the moving unit 21 that carries the covered wires 3, the drain wire 4, the ALS sheets 105, and the PET sheets 106, the ALS-wrapped wire bundle covered by the PET sheets 106 can be moved with the edges 106a and 106b of the PET sheets 106 held by the fixed unit 120. Thus, the one edge 106a and the other edge 106b of the PET sheet 6 can be joined together uninterruptedly over the entire length of the PET sheets 106. Also, the occurrence of a gap in the welded portion can be prevented and accordingly exposure of the ALS sheets 105 to an outside can be effectively prevented.

Since the driven gear 37 holds the covered wire 3 at the center of the driven gear 37 and holds the drain wire 4 at the peripheral region of the driven gear 37 and the covered wires 3 are turned for at least one round of rotation, at least a portion of the drain wire 4 can be placed at a periphery relative to the cross section of the wire bundle so as to ensure that the drain wire 4 is brought into contact with the ALS sheets 105 wound around the wire bundle. Accordingly, the electrical noise can be effectively led via the drain wire 4 to the ground circuit.

Although, in the aforementioned embodiment, the shield harness 102 has the plurality of covered wires 3 and one drain wire 4, the shield harness 102 of the present invention can be effectuated with at least one covered wire 3 and at least one drain wire 4.

In addition, the edges of the PET sheets 106 are joined together by welding. However, joining together of the edges of the PET sheets 106 can be achieved by adhesive bonding using a suitable adhesive.

### Third Embodiment

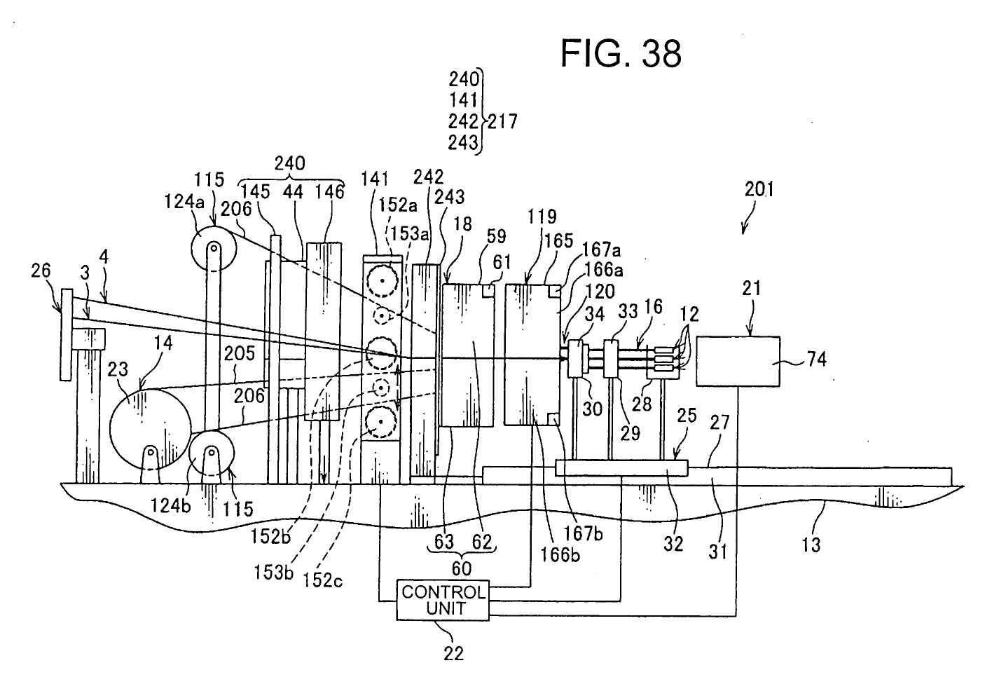

The shield harness manufacturing device according to the third embodiment of the present invention is described with reference to FIGS. 38 to 41. In the second embodiment, the covered wires 3 and the drain wire 4 are wrapped in the two ALS sheets 105 opposed to each other, the covered wires 3, the drain wire 4, and the ALS sheets 105 are placed between the two PET sheets 106 opposed to each other are wrapped in the two PET sheets 106, and the one edges 106a and 106a and the other edges 106b and 106b of the two PET sheets 106 are welded together over the entire length of the PTE sheets 205.

In contrast, however, the third embodiment involves one ALS sheet 205 that is wound around the wire bundle of the covered wires 3 and the drain wire 4. Thus, the covered wires 3 and the drain wire 4, and the ALS sheet 205 are placed between two PET sheets 206 opposed to each other and wrapped in the PET sheets 206. The one edges 206a and 206a and the other edges 206b and 206b in the width direction of the PET sheets 206 are welded together over the entire length of the. PET sheets 206. It should be noted that the constituent parts and components that have already appeared in the description of the first and second embodiments are indicated by the same reference numerals and the third embodiment will not reiterate their constructions and arrangements that have already been exhaustively discussed in the previous embodiments.

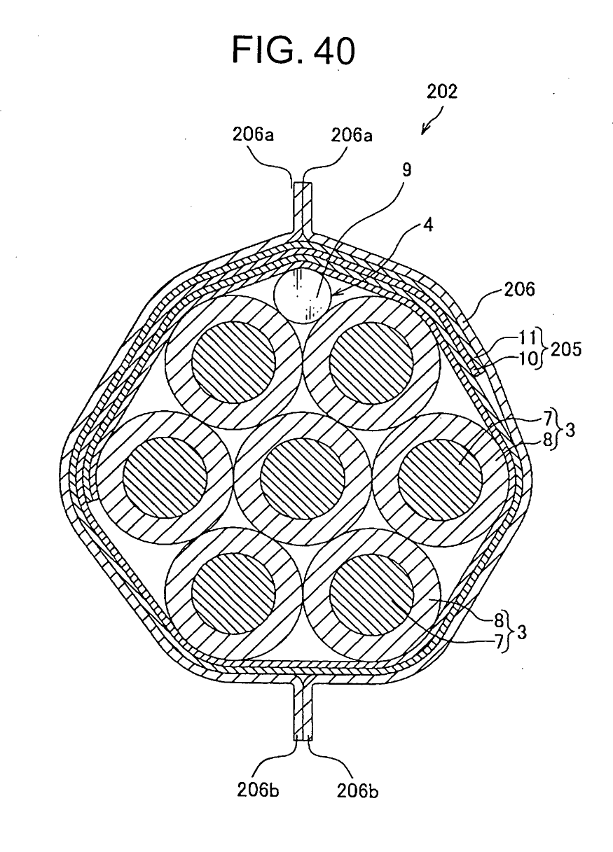

The manufacturing device 201 shown in FIG. 38 is an apparatus that manufactures the shield harness 202 shown in FIG. 40. The shield harness 202, as shown in FIG. 40, has a plurality of electrical wires, i.e., at least one covered wire 3 and one drain wire 4, and an aluminum-laminated sheet (ALS sheet) 205 as an electrically conductive sheet, and a PET sheet 206 as an electrically insulating sheet.

The ALS sheet 205 is a relatively thin sheet that includes a thin conductive layer 10 and an insulating layer 11 laminated onto the conductive layer 10. The ALS sheet 205 is formed in a shape of a strip. The ALS sheet 205 is wound around the bundle of the covered wires 3 and the drain wire 4 such that the conductive layer 10 of the ALS sheet 205 comes radially inward of the cross-section of the wire bundle. As shown in FIG. 40, the conductive layer 10 of the ALS sheet 205 is in contact with the drain wire 4 at a peripheral region of the shield harness 202.

The PET sheet 206 is made of flexible and electrically insulating synthetic resin such as polyethylene terephthalate, and formed in a shape of a relatively thin sheet. The two PET sheets 206 are formed in a shape of a strip.

The shield harness 202 is manufactured by binding the plurality of covered wires 3 and the drain wire 4 into a bundle (note that use of a binding means such as a tape is not presupposed in the preferred embodiments) and then the wire bundle is wrapped first in the ALS sheet 205 with its conductive layer 10 coming radially inward, and the ALS-wound wire bundle is further wrapped in the PET sheet 206. Here, the ALS sheet 205 and the PET sheets 206 are arranged lengthwise parallel to the covered wires 3 and the drain wire 4. The ALS sheet 205 is wound around the wire bundle including the covered wires 3 and the drain wire 4, and the two PET sheets 206 sandwich the ALS-wound wire bundle so that the covered wires 3, the drain wire 4, and the ALS sheet 205 are wrapped in the PET sheets 206. Further, one edges 206a and 206a of the PET sheets 206 are welded together and the other edges 206b and 206b thereof are likewise welded together over the entire length of the PET sheets 206.

Referring to FIG. 38, the manufacturing device 201 has the body 13, the ALS feeder 14, the PET feeder 115, the electrical-wire-holding unit 16, a guide unit 217, the conductor-winding unit 18, the insulator-winding unit 119, the fixed unit 120, the movable unit 21, and the control unit 22.

The ALS feeder 14 and the PET feeder 115 are provided on the flat upper surface of the body 13 of the manufacturing device 201. The feeders 14 and 115 are rotatably supported by the body 13 and have a reel 23 around which the ALS sheet 205 in a shape of an elongated strip is wound and reels 124a and 124b around which the PET sheets 206 are wound, respectively.

The reels 124a and 124b around which the PET sheets 206 are wound are provided at a position where the covered wires 3, the drain wire 4, and the reel 23 around which the ALS sheet 205 is wound are found between the reels 124a and 124b in the vertical direction. Also, the reel 124a and the reel 124b are arranged on one straight line perpendicular to the longitudinal direction of the body 13. The one reel 124a is provided higher in the vertical direction than the reel 23 around which the ALS sheet 205 is wound. The other reel 124b is provided lower than the reel 23 around which the ALS sheet 205 is wound.

Referring to FIG. 38, the guide unit 217 includes a fixed guide 240, the sheet feeder 141, a multiple-component-type guide 242, and a sliding blade 243. The guide unit 217 is provided near the feeders 14 and 115 and between the feeders 14, 115 and the movable holding unit 25. The fixed guide 240 is provided near the feeders 14, 115 and includes the ALS-guide 44, the first PET-guide 145, and the second PET-guide 146.

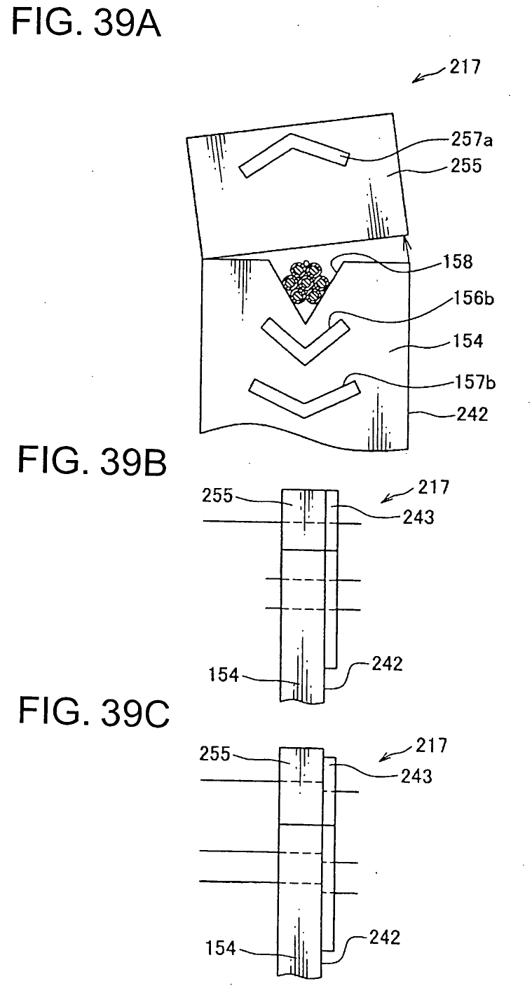

The multiple-component-type guide 242 is provided near the sheet feeder 141 and closer to the movable holding unit 25 than the sheet feeder 141 is. The multiple-component-type guide 242, as shown in FIG. 39A, has the lower guide portion 154 and an upper guide portion 255.

The upper guide portion 255 is formed in a shape of a quadratic prism. The upper guide portion 255 is provided on an upper end of the lower guide portion 154 rotatably from a position where the opening above the electrical-wire-guiding groove 158 is closed to the position where the opening is left open.

The PET-guide hole 257a extends through the upper guide portion 255 in the longitudinal direction of the body 13 of the manufacturing device 201. The PET-guide hole 257a has an inverted-V-shaped cross-section. When the upper guide portion 255 is positioned in the position where the opening of the electrical-wire-guiding groove 158 is closed, the PET-guide hole 257a and the PET-guide hole 157b are arranged such that they come close to each other in the longitudinal direction of the body 13. The PET sheet 206 is passed through the PET-guide hole 257a.

The sliding blade 243 is formed in a shape of a strip and in contact with the lateral surface of the lower guide portion 154 and the upper guide portion 255 of the multiple-component-type guide 242, the lateral surface being opposed to the movable holding unit 25. The sliding blade 243 is slidable in the vertical direction. The sliding blade 243 has guide holes (not shown) operable to register with the ALS-guide hole 156b and the PET-guide holes 257a and 157b, and inside of which the ALS sheet 205 and the PET sheet 206 are passed. The sliding blade 243 slides in the vertical direction relative to the lower guide portion 154 and the upper guide portion 255, and cuts the ALS sheet 205 and the PET sheet 206 on the lower guide portion 154 and the upper guide portion 255.

The following describes how the shield harness 202 is manufactured by the manufacturing device 201 by applying first the ALS sheet 205 and then the two PET sheets 206 around the covered wires 3 and the drain wire 4 that are cut in the predetermined length with the terminal fittings 12 attached to the both ends thereof.

As preparatory operation, the terminal fitting 12 is attached to one end of the covered wires 3 and the drain wire 4. Then the covered wires 3 and the drain wire 4 are hooked onto the terminal holder 28 of the movable holding unit 25 of the electrical-wire-holding unit 16, and then the one end of the covered wires 3 and the drain wire 4 is held by the terminal holder 28. Meanwhile, the other end of the covered wire 3 is inserted into the electrical-wire-holding slit 38 of the driven gear 37 of the rotatable holding unit 26 such that the other end of the covered wires 3 are held. Likewise, the other end of the drain wire 4 is inserted into the drain-wire-holding slit 39 of the driven gear 37 of the rotatable holding unit 26 so that the other end is held. Further, the central portion of the covered wires 3 and the drain wire 4 is received in the electrical-wire-guiding groove 158 of the multiple-component-type guide 242 of the guide unit 217, and the opening of the electrical-wire-guiding groove 158 is closed by the cover 255.

Further, the tip of the ALS sheet 205 wound around the reel 23 of the ALS feeder 14 is passed through the guide hole 47 of the ALS-guide 44 of the fixed guide 240 of the guide unit 217 and then between the fixed pulley 152b and the movable pulley 153b of the sheet feeder 141, and further into the ALS-guide hole 156b formed on the lower guide portion 154 of the multiple-component-type guide 242 so as to be in contact with the sliding blade 243.

Also, the tip of the PET sheet 206 wound around the reel 124a of the PET feeder 115 is passed (in order of appearance below) through the guide hole 148a of the first PET-guide 145 of the fixed guide 240 of the guide unit 217, between the guide rollers 50 of the second PET-guide 146, and between the fixed pulley 152a and the movable pulley 153a of the sheet feeder 141. The tip of the PET sheet 206 is inserted into the PET-guide hole 257a provided on the upper guide portion 255 of the multiple-component-type guide 242 so as to be in contact with the sliding blade 243.

Likewise, the tip of the PET sheet 206 wound around the reel 124b of the PET feeder 115 is passed (in order of appearance below) through the guide hole 148b of the first PET-guide 145 of the fixed guide 240 of the guide unit 217, between the guide rollers 50 of the second PET-guide 146, and between the fixed pulley 152b and the movable pulley 153b of the sheet feeder 141. The tip of the PET sheet 206 is inserted into the PET-guide hole 157b provided on the lower guide portion 154 of the multiple-component-type guide 242 so as to be in contact with the sliding blade 243.

Upon completion of the preparatory operation, the manufacturing device 201 is ready to start manufacturing operation.

First, the movable pulley 153b is moved close to the fixed pulley 152b of the sheet feeder 141 of the guide unit 217. Then the ALS sheet 205 is sandwiched between the pulleys 152b and 153b.

The sliding blade 243 is placed at a position where the guide holes of the sliding blade 243 register with and communicate with the guide holes 156b, 257a, and 157b of the multiple-component-type guide 242 (shown in FIG. 39B).

The main mold 166 of the insulator-winding unit 119 is placed at a position where the main mold 166 is not closely aligned with the conductor-winding unit 18 in the longitudinal direction of the body 13 of the manufacturing device 201. The upper mold 166a of the main mold 166 of the insulator-winding unit 119 and the clamping mold 167a mounted on the upper mold 166a are raised integrally, and the lower mold 166b and the clamping mold 167b mounted on the lower mold 166b are lowered integrally.

The slider 32 of the movable holding unit 25 (and accordingly the terminal holder 28, the electrical-wire-chuck portion 29, and the sheet-chuck portion 30) is placed most proximate to the conductor-winding unit 18, and the pair of chuck members 33 of the electrical-wire-chuck portion 29 are moved close to each other, so that the covered wires 3 and the drain wire 4 are sandwiched between them. Further, the pair of chuck members 34 of the sheet-chuck portion 30 are spaced from each other. The pair of belt units 74 of the movable unit 21 are also spaced from each other. The horn 172 and the anvil 173 of the one fixed unit 120 are spaced from each other. Likewise, the horn 172 and the anvil 173 of the other fixed unit 120 are spaced from each other.

Thereafter, the upper mold 63 and the lower mold 62 of the conductor-winding unit 18 are closely overlapped with each other, so that the covered wires 3 and the drain wire 4 are sandwiched between the lower molds 62 and the upper mold 63. Also, the covered wires 3 and the drain wire 4 are passed through the conductor-winding mold 59.

After that, the motor (not shown) drives and rotates the movable pulley 153b of the sheet feeder 141, so that the ALS sheet 205 is fed into the through-hole 64 of the main mold 60 of the conductor-winding mold 59 of the conductor-winding unit 18. Since the diameter of the through-hole 64 gradually decreases toward the side of movable holding unit 25, the ALS sheet 205 is guided by the inner surface of the through-hole 64, and gradually applied around the wire bundle (i.e., the covered wires 3 and the drain wire 4).

When the tip of the ALS sheet 205 is passed thorough the through-hole 64 and placed between the pair of chuck members 34 of the sheet-chuck portion 30, the movable pulley 153b of the sheet feeder 141 stops rotating. The pair of chuck members 34 of the sheet-chuck portion 30 move close to each other, and thus the tip of the covered wires 3, the drain wire 4, and the ALS sheet 205 is sandwiched between the chuck members 34.

Following this, the fastening mold 161a of the conductor-winding mold 59 is lowered and the tip of the covered wires 3, the drain wire, and the ALS sheet 5 is sandwiched against the fastening molds 161a and 161b. After that, the ALS sheet 205 is applied around the wire bundle such that the wire bundle and the ALS sheet 205 is in intimate contact with each other.

After that, the slider 32 of the movable holding unit 25 (and accordingly the terminal holder 28, the electrical-wire-chuck portion 29, and the sheet-chuck portion 30) is moved away from the conductor-winding unit 18. Further, the insulator-winding mold 165 is moved along with the movable unit 21 of the insulator-winding unit 119, so that the insulator-winding mold 165 is placed at a position where the insulator-winding mold 165 is closely aligned with the conductor-winding mold 59 of the conductor-winding unit 18 in the longitudinal direction of the body 13 of the manufacturing device 201. In this manner, the insulator-winding unit 119 is placed between the conductor-winding unit 18 and the movable holding unit 25. Thereafter, the pair of chuck members 34 of the sheet-chuck portion 30 are moved away from each other. The movable pulley 153b is moved close to the fixed pulley 152c, so that the two PET sheets 206 are sandwiched between the pulleys 152c and 153a and between the pulleys 152c and 153b, respectively.

Thereafter, the upper mold 166a is closely overlapped with the lower mold 166b. The guide groove 169a of the upper mold 166a registers with the guide groove 169b of the lower mold 166b. The ALS-wound wire bundle is received in the through-hole defined by the two guide groove 169a, 169b.

After that, the motor (not shown) rotates the movable pulleys 153a and 153b of the sheet feeder 141. Thereafter, one of the two PET sheets 206 opposed to each other is fed toward the through-hole 175a of the upper mold 166a of the main mold 166 of the insulator-winding mold 165 of the insulator-winding unit 119, and the other of the two PET sheets 206 is fed toward the through-hole 175b of the lower mold 166b of the main mold 166 of the insulator-winding mold 165 of the insulator-winding unit 119. After that, the through-hole 175a of the upper mold 166a of the main mold 166 makes the one of the two PET sheets 206 take a U-shaped cross-section. Meanwhile, the through-hole 175b of the lower mold 166b of the main mold 166 makes the other of the two PET sheets 206 take a U-shaped cross-section. The PET sheets 206 having the U-shaped cross-section are placed at the periphery of the ALS-wound wire bundle.

Thereafter, the tip of the PET sheets 206 on the wire-rest portion 171a is passed through the pair of clamping portions 168a and 168b and positioned between the pair of chuck members 34 of the sheet-chuck portion 30. Then the movable pulleys 153a and 153b of the sheet feeder 141 stop rotating, and the pair of chuck members 34 of the sheet-chuck portion 30 are moved close to each other. The tip of the covered wires 3, the drain wire 4, the ALS sheet 205, and the PET sheets 206 are sandwiched between the chuck members 34. Following this, the clamping molds 167a and 167b of the insulator-winding mold 165 are moved close to each other. Thus, one edges 206a and the other edges 206b of the two PET sheets 206 are pressed by the surfaces A and B of the clamping mold 167a and 167b, respectively.

Thereafter, the clamping molds 167a and 167b of the insulator-winding mold 165 are moved close to each other, and the surfaces A and B of the clamping portions 168a and 168b are, tough not in complete contact, but yet very close to each other with a limited degree of gaps left therebetween. The clamping portions 168a and 168b are very close to each other, and the ALS-wound wire bundle is wrapped in the two PET sheets 206, which are now brought into close contact with each other.

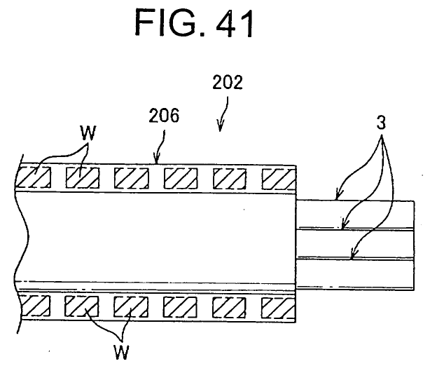

Following this, the horn 172 and the anvil 173 of one of the two fixed units 120 are moved close to each other so that the one edge 206a of the one PET sheet 206 and the one edge of the other PET sheet 206 are clamped between the horn 172 and the anvil 173 of the one fixed unit 120 with the horn 172 under ultrasonic vibration by the ultrasonic oscillator. Likewise, the horn 172 and the anvil 173 of the other fixed unit 120 are moved close to each other so that the other edge 206b of the one PET sheet 206 and the other edge of the other PET sheet 206 are clamped between the horn 172 and the anvil 173 of the other fixed unit 120 with the horn 172 under ultrasonic vibration by the ultrasonic oscillator. Then, frictional heat occurs at portions of the one edges 206a and the other edges 206b of the PET sheets 206 that are clamped between the corresponding horn 172 and anvil 173 and, as a result, the edges 206a and 206b of the PET sheets 206 are welded together. Thereafter, the slider 32 of the movable holding unit 25 (and accordingly the terminal holder 28, the electrical-wire-chuck portion 29, and the sheet-chuck portion 30) is moved away from the conductor-winding unit 18. As the movable holding unit 25 is moving, the covered wires 3, the drain wire 4, the ALS sheet 205, and the PET sheets 206 are moved away from the conductor-winding unit 18, and the portions of the one edges 206a and the other edges 206b of the PET sheets 206 that are clamped between the horn 172 and the anvil 173 are also moved, and as a result the one edges 206a and the other edges 206b of the PET sheets 206 are welded in the longitudinal direction in response to movement relative to the conductor-winding unit 18. This means that, as shown in FIG. 41, the one edges 206a in the width direction of the two PET sheets 206 are welded together and likewise the other edges 206b are welded together, so that the welded portions W are provided at given intervals over the entire length of the covered wires 3, the drain wire 4, the ALS sheet 205, and the PET sheets 206.

After that, when the slider 32 of the movable holding unit 25 (and accordingly the terminal holder 28, the electrical-wire-chuck portion 29, and the sheet-chuck portion 30) is placed at a position more distant from the rotatable holding unit 26 than the pair of belt units 74 of the movable unit 21 are, then the slider 32 stops moving. Thereafter, the pair of belt units 74 of the movable unit 21 are moved close to each other, so that the PET sheets 206 covering the ALS-wound wire bundle is sandwiched between the belt units 74. Also, the pair of chuck members 33 of the electrical-wire-chuck portion 29 are moved away from each other, and the pair of chuck members 34 of the sheet-chuck portion 30 are moved away from each other, and the driving pulley of the belt unit 74 of the movable unit 21 is rotated. Further, the covered wires 3, the drain wire 4, and the ALS sheet 5, and the PET sheets 6 are moved integrally away from the feeders 14 and 115.

Thereafter, when the ALS sheet 205 and the PET sheets 206 are moved for a predetermined distance, as shown in FIG. 27C, the sliding blade 243 slides relative to the multiple-component-type guide 242, and cuts the ALS sheet 205 and the PET sheets 206, and, immediately before sliding of the sliding blade 243 and accordingly immediately before cutting of the ALS sheet 205 and the PET sheets 206, the motor of the rotatable holding unit 26 is driven to cause only one round of rotation of the driven gear 37. After that, since the other end of the drain wire 4 is held at a periphery of the driven gear 37, the drain wire 4 is positioned at a peripheral region of the circular cross section of the wire bundle, and comes into direct contact with the conductive layer 10 of the ALS sheet 5. Thus, the rotatable holding unit 26 of the electrical-wire-holding unit 16 controlled by the control unit 22 causes at least one round of rotation of the driven gear 37.

Following this, the sliding blade 243 slides again, and the sliding blade 243 is placed at a position where the guide holes of the sliding blade 243 register with the ALS-guide hole 156b and the PET-guide holes 157a and 157b of the multiple-component-type guide 242, and the endless belt of the belt unit 74 of the movable unit 21 runs so that the ALS-wound wire bundle and the PET sheets 206 covering the ALS-wound wire bundle are moved to a position more distant from the feeders 14 and 115 than the movable holding unit 25 is.

The manufacturing of the shield harness 202 is thus completed.

The shield harness manufacturing device and the shield harness manufacturing method according to the third embodiment of the present invention have the following advantages.

The conductor-winding mold 59 is provided to apply the ALS sheet 205 around the wire bundle constituted by the covered wires 3 and the drain wire 4, and the insulator-winding mold 165 is provided to apply the PET sheets 206 around the ALS-wound wire bundle. Thus, the shield harness 202 is manufactured by wrapping the wire bundle first in the ALS sheet 205 and then in the PET sheets 206 around the bundle of the covered wires 3 and the drain wire 4.

Accordingly, the shield harness 202 can be made more light-weight since the need of covering the external surface of the ALS sheet 205 by an insulating synthetic resin is eliminated. Also, since the PET sheets 206 covers the external surface of the ALS sheet 205, the ALS sheet 205 wound around the wire bundle can be protected against being exposed to an outside, and thus shielding performance of the shield harness 202 can be improved.

Also, the conductor-winding mold 59 winds the ALS sheet 205 around the covered wires 3 and the drain wire 4. Since the readily-plastically-deformed ALS sheet 205 are wound around the periphery of the wire bundle, the covered wire 3 and the drain wire 4 can be wrapped in the ALS sheet 205 more adhesively and snugly, in stable contact with the electrical wire. Accordingly, the ALS sheet 205 can be effectively wound around the covered wires 3 and the drain wire 4.

Further, the insulator-winding molds 165 sandwiches the ALS sheet 205 therebetween for covering the ALS-wound wire bundle by the PET sheets 206. Since the not-readily-plastically-deformed PET sheets 206 are placed such that the wire bundle is sandwiched therebetween, the PET sheets 206 can be applied without causing damage to the PET sheets 206. Accordingly, the covered wires 3, the drain wire 4, and the ALS sheet 205 covering the wires can be effectively wrapped in the PET sheets 206.

In addition, since the ends 206a and 206a, and ends 206b and 206b are welded together over the entire length of the two PET sheets 206, adjustment can be readily achieved by shifting the welded portions W of the two PET sheets 206 in the width direction of the PET sheets 206 in response to changes in the number and diameter of the covered wires 3 that are covered by the PET sheets 206.

Also, since the ALS sheet 205 that are wound around the wire bundle by the conductor-winding mold 59 is readily plastically deformed. The ALS sheet 205 can be wound more adhesively and snugly, in more stable contact with the covered wire 3 and the drain wire 4. Accordingly, the ALS sheet 205 can be wound around the wire bundle effectively.

Since the covered wires 3, the drain wire 4, and the ALS sheet 205 are inserted into the through-holes 64 of the main mold 60 of the conductor-winding mold 59, the diameter of the through-holes 64 gradually decreasing, the ALS sheet 205 can be effectively wound around the wire bundle.

In addition, since the ALS sheet 205 are sandwiched between the fastening molds 61, the wound ALS sheet 5 is clamped between the two molds so that the ALS sheet 205 can be snugly wound around the wire bundle.

Since the main mold 166 of the insulator-winding mold 165 holds the PET sheets 206 in such a manner that the cross-section of the PET sheets 206 has an U-shape and the one edge 206a of the one PET sheet 206 and the one edge 206a of the other PET sheet 206 are clamped between the pair of clamping molds 167a and 167b, and likewise the other edge 206b of the other PET sheet 206 and the other edge 206 of the PET sheet 206 are clamped between the pair of clamping molds 167a and 167b, the PET sheets 206 can be effectively wound around the ALS-wound wire bundle.

Since the corresponding two each of the edges 206a and 206b of the PET sheets 206 are joined with each other by the fixed unit 120, the corresponding edges of the PET sheets 206 can be joined together with the PET sheets 206 wound around the covered wires 3, the drain wire 4, and the ALS sheet 205.

By virtue of the moving unit 21 that carries the covered wires 3, the drain wire 4, the ALS sheet 205, and the PET sheets 206, the ALS-wound wire bundle covered by the PET sheets 206 can be moved with the edges 206a and 206b of the PET sheets 206 held by the fixed unit 120. Thus, the one edge 206a and the other edge 206b of the PET sheet 206 can be joined together over the entire length of the PET sheet 206. Also, the occurrence of a gap in the welded portion W can be prevented and accordingly exposure of the ALS sheet 205 to an outside can be effectively prevented. In addition, since the welded portions W are provided at the given intervals, processing time required to complete the welding of the PET sheets 205 can be shortened when compared with the welding step where the edges of the PET sheets 206 are welded together uninterruptedly over the entire length of the PET sheets 206.

Since the driven gear 37 holds the covered wire 3 at the center of the driven gear 37 and holds the drain wire 4 at the peripheral region of the driven gear 37 and the covered wires 3 are turned for at least one round of rotation, at least a portion of the drain wire 4 can be placed at a periphery relative to the cross section of the wire bundle so as to ensure that the drain wire 4 is brought into contact with the ALS sheet 205 wound around the wire bundle. Accordingly, the electrical noise can be effectively led via the drain wire 4 to the ground circuit.

Although, in the third embodiment, the shield harness 202 has the plurality of covered wires 3 and one drain wire 4, the shield harness 202 of the present invention can be effectuated with at least one covered wire 3 and at least one drain wire 4.

In addition, the edges of the PET sheets 206 are joined together by welding. However, joining together of the edges of the PET sheets 206 can be achieved by adhesive bonding using a suitable adhesive.

Having now fully described the preferred embodiment of the present invention, it is clear that the descriptions and explanation contained herein are only cited by way of example rather than limitation, and therefore the present invention can be effectuated with modifications, changes, variations, substitutions, and equivalents without departing from the scope and sprit of the present invention as defined by the appended claims.

What is claimed is:

1. A method for manufacturing a shield harness including an electrical wire, a conductive sheet covering the covered wire, and an insulating sheet covering the conductive wire, the method comprising the steps of:
(a) winding the conductive sheet around the electrical wire over a length of the electrical wire with one end of the electrical wire being secured;
(b) folding the insulating sheet lengthwise such that the electrical wire and the conductive sheet wound around the electrical wire is placed between two halves of the insulating sheet;
(c) winding the folded insulating sheet around the conductive sheet; and
(d) welding or adhesive-bonding together one edge of the insulating sheet and the other edge of the insulating sheet over a length of the insulating sheet, with the one edge of the insulating sheet overlapped with the other edge of the insulating sheet over the length of the insulating sheet.

2. A method for manufacturing a shield harness including an electrical wire, a conductive sheet covering the covered wire, and first and second insulating sheets covering the conductive wire, the method comprising the steps of:
(a) winding the conductive sheet around the electrical wire over a length of the electrical wire with one end of the electrical wire being secured;
(b) feeding the first insulating sheet and the second insulating sheet such that the electrical wire and the conductive wire wound around the electrical wire are positioned between the first insulating sheet and the second insulating sheet over the length of the electrical wire;
(c) wrapping the electrical wire and the conductive sheet in the first and second insulating sheets; and
(d) welding or adhesive-bonding together one edge of the first insulating sheet and one edge of the second insulating sheet over a length of the insulating sheets, and welding together the other edge of the first insulating sheet and the other edge of the second insulating sheet over the length of the insulating sheets, with the one edge of the first insulating sheet overlapped with the one edge of the second insulating sheet over the length of the insulating sheets, and with the other edge of the first insulating sheet overlapped with the other edge of the second insulating sheet over the length of the insulating sheets.
